(19) United States
(12) Patent Application Publication
(10) Pub. No.: US 2022/0179991 A1
(43) Pub. Date: Jun. 9, 2022

(54) AUTOMATED LOG/EVENT-MESSAGE MASKING IN A DISTRIBUTED LOG-ANALYTICS SYSTEM

(71) Applicant: VMware, Inc., Palo Alto, CA (US)

(72) Inventors: Ritesh Jha, Bangalore (IN); Chandrashekhar Jha, Bangalore (IN); Nikhil Jaiswal, Bangalore (IN); Jobin Raju George, Bangalore (IN); Vaidic Joshi, Bangalore (IN)

(73) Assignee: VMware, Inc., Palo Alto, CA (US)

(21) Appl. No.: 17/115,197

(22) Filed: Dec. 8, 2020

(51) Int. Cl. G06F 21/62; G06F 11/34; G06N 20/00

(52) U.S. Cl. CPC G06F 21/6245; G06N 20/00; G06F 11/3476

(57) ABSTRACT

The current document is directed to methods and systems that efficiently and accurately process log/event messages generated within distributed computer facilities. Various different types of initial processing steps may be applied to a stream of log/event messages received by a message-collector system and/or a message-ingestion-and-processing system, including masking sensitive fields to prevent exposure of confidential and sensitive information contained in log/event messages. Rule-based identification and masking of sensitive fields in log/event messages is currently provided by certain automated log/event-message systems, but current approaches suffer numerous deficiencies. The methods and systems to which the current document is directed automatically create sensitive-field dictionaries and associated logic and/or train machine-learning components to automatically identify and mask fields within log/event messages in order to address the deficiencies of traditional rule-based sensitive-field identification and masking.

### TECHNICAL FIELD

The current document is directed to distributed-computer-systems and, in particular, to methods and systems that efficiently and accurately process log/event messages generated within distributed computer facilities.

### BACKGROUND

During the past seven decades, electronic computing has evolved from primitive, vacuum-tube-based computer systems, initially developed during the 1940s, to modern electronic computing systems in which large numbers of multi-processor servers, work stations, and other individual computing systems are networked together with large-capacity data-storage devices and other electronic devices to produce geographically distributed computing systems with hundreds of thousands, millions, or more components that provide enormous computational bandwidths and data-storage capacities. These large, distributed computing systems are made possible by advances in computer networking, distributed operating systems and applications, data-storage appliances, computer hardware, and software technologies. However, despite all of these advances, the rapid increase in the size and complexity of computing systems has been accompanied by numerous scaling issues and technical challenges, including technical challenges associated with communications overheads encountered in parallelizing computational tasks among multiple processors, component failures, and distributed-system management. As new distributed-computing technologies are developed, and as general hardware and software technologies continue to advance, the current trend towards ever-larger and more complex distributed computing systems appears likely to continue well into the future.

As the complexity of distributed computing systems has increased, the management and administration of distributed computing systems has, in turn, become increasingly complex, involving greater computational overheads and significant inefficiencies and deficiencies. In fact, many desired management-and-administration functionalities are becoming sufficiently complex to render traditional approaches to the design and implementation of automated management and administration systems impractical, from a time and cost standpoint, and even from a feasibility standpoint. Therefore, designers and developers of various types of automated management-and-administration facilities related to distributed computing systems are seeking new approaches to implementing automated management-and-administration facilities and functionalities.

### SUMMARY

The current document is directed to methods and systems that efficiently and accurately process log/event messages generated within distributed computer facilities. Various different types of initial processing steps may be applied to a stream of log/event messages received by a message-collector system and/or a message-ingestion-and-processing system, including masking sensitive fields to prevent exposure of confidential and sensitive information contained in log/event messages. Rule-based identification and masking of sensitive fields in log/event messages is currently provided by certain automated log/event-message systems, but current approaches suffer numerous deficiencies. The methods and systems to which the current document is directed automatically create sensitive-field dictionaries and associated logic and/or train machine-learning components to automatically identify and mask fields within log/event messages in order to address the deficiencies of traditional rule-based sensitive-field identification and masking.

### BRIEF DESCRIPTION OF THE DRAWINGS

FIG. 1 provides a general architectural diagram for various types of computers.

FIG. 2 illustrates an Internet-connected distributed computing system.

FIG. 3 illustrates cloud computing.

FIG. 4 illustrates generalized hardware and software components of a general-purpose computer system, such as a general-purpose computer system having an architecture similar to that shown in FIG. 1.

FIGS. 5A-D illustrate two types of virtual machine and virtual-machine execution environments.

FIG. 6 illustrates an OVF package.

FIG. 7 illustrates virtual data centers provided as an abstraction of underlying physical-data-center hardware components.

FIG. 8 illustrates virtual-machine components of a VI-management-server and physical servers of a physical data center above which a virtual-data-center interface is provided by the VI-management-server.

FIG. 9 illustrates a cloud-director level of abstraction.

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds.

FIG. 11 shows a small, 11-entry portion of a log file from a distributed computer system.

FIG. 12 illustrates generation of log/event messages within a server.

FIGS. 13A-B illustrate two different types of log/event-message collection and forwarding within distributed computer systems.

FIG. 14 provides a block diagram of a generalized log/event-message system incorporated within one or more distributed computing systems.

FIG. 15 illustrates log/event-message preprocessing.

FIG. 16 illustrates processing of log/event messages by a message-collector system or a message-ingestion-and-processing system.

FIGS. 17A-C provide control-flow diagrams that illustrate log/event-message processing within currently available message-collector systems and message-ingestion-and-processing systems.

FIG. 18 illustrates various common types of initial log/event-message processing carried out by message-collector systems and/or message-ingestion-and-processing systems.

FIG. 19 illustrates processing rules that specify various types of initial log/event-message processing.

FIGS. 20A-B provide a simple example of the types of errors that may be encountered when message-processing rules are manually specified or programmatically generated.

FIGS. 21A-B illustrate a log/event-message-type generation method.

FIGS. 22A-C illustrate a clustering technique for generating an event_type( ) function and extraction and message-restoration functions ƒ( ) and ƒ¹( ).

FIGS. 23A-B illustrate a machine-learning technique for generating an event_type( ) function and extraction and message-restoration functions ƒ( ) and ƒ¹( ).

FIGS. 24A-C illustrate one approach to extracting fields from a log/event message.

FIG. 25 shows an example log/event message that includes confidential and sensitive information.

FIG. 26 illustrates various of the potential confidential-and-sensitive-information points of exposure related to a log/event-message system within a distributed computer system.

FIG. 27 illustrates a basis for one approach to providing masking rules to implement masking of confidential sensitive information in log/event messages by rule-based log/event-message processing.

FIGS. 28A-B provide control-flow diagrams for a routine “apply masking rule,” which applies a masking rule to a log/event message to identify and locate a sensitive field specified by a pre-context/regular-expression/post-context triple in the criteria portion of the masking rule.

FIGS. 29A-C show basic components and features of the currently disclosed automated sensitive-field masking methods employed within log/event-message subsystems.

FIGS. 30A-B and 31 illustrate one approach to implementing a sensitive-field dictionary using relational-database tables.

FIG. 32 illustrates progressive determination of a regular expression for the contents of a sensitive log/event-message field.

FIG. 33 illustrates various text-processing operations used in the currently disclosed log/event-message masking subsystems to generate a canonical context from a raw context associated with a sensitive field in a log/event message.

FIGS. 34A-C provide control-flow diagrams that illustrate one implementation of a dictionary-creation routine used by a masking subsystem of a log/event-message subsystem.

FIGS. 35A-E illustrate a windowing approach to analyzing a received log/event message to identify any sensitive fields within the received log/event message.

FIGS. 36A-B provide control-flow diagrams that illustrate application of automated masking to a received log/event message.

FIGS. 37A-C illustrate machine-reading-comprehension (“MRC”) systems.

FIG. 38 illustrates training an MRC system to identify sensitive fields in log/event messages.

FIG. 39 provides an alternative implementation for the routine “apply automated masking.”

FIG. 40 illustrates incorporation of automatic-masking subsystem within a log/event-message subsystem.

### DETAILED DESCRIPTION

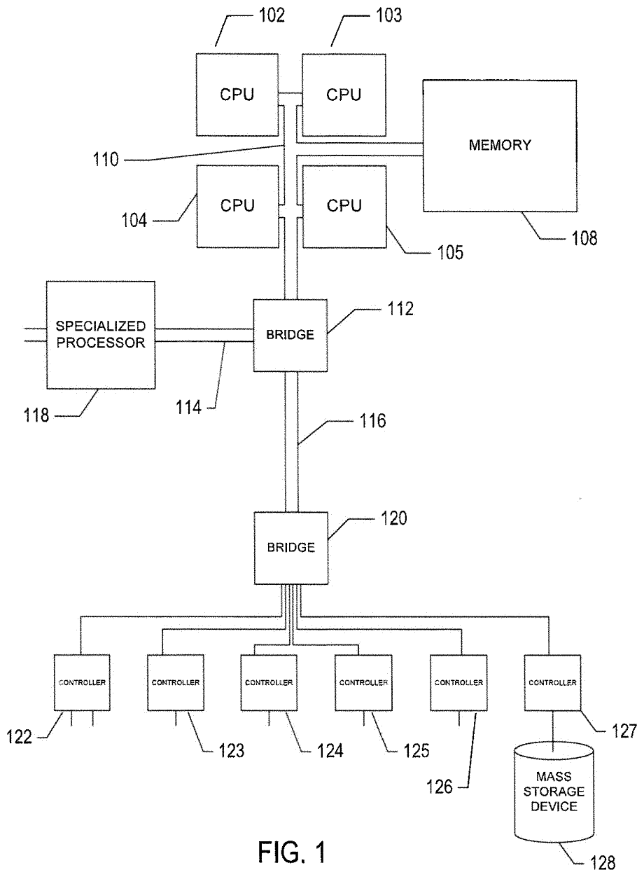

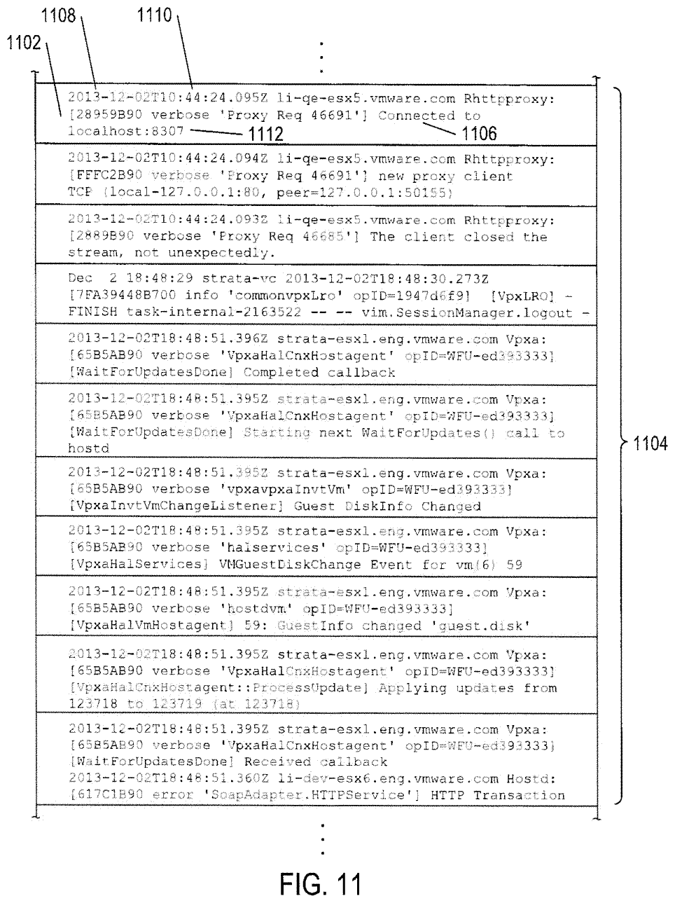

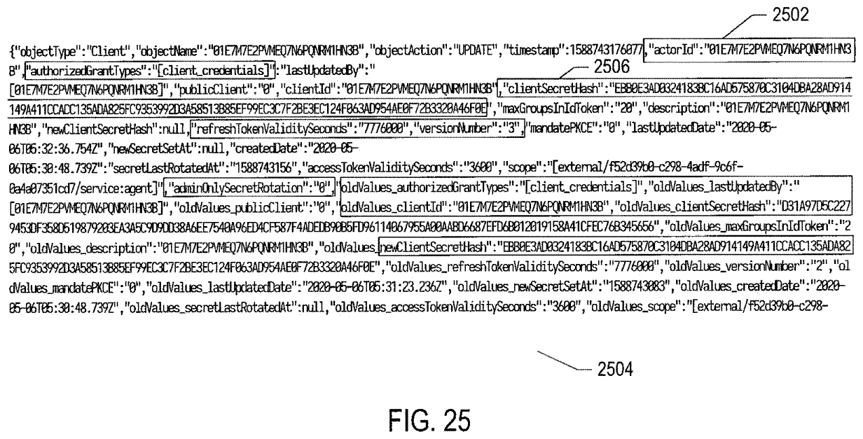

The current document is directed to methods and systems that efficiently and accurately process log/event messages generated within distributed computer facilities. In a first subsection, below, a detailed description of computer hardware, complex computational systems, and virtualization is provided with reference to FIGS. 1-10. In a second subsection, log/event-message systems are discussed with reference to FIGS. 11-24C. In a third subsection, the currently disclosed methods and systems are discussed with reference to FIGS. 25-39.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 provides a general architectural diagram for various types of computers. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

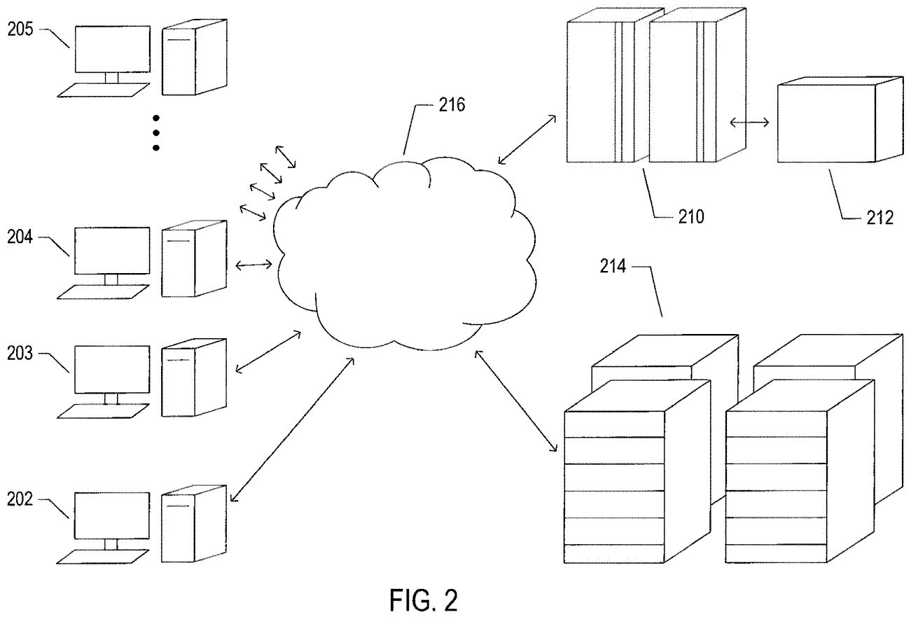

FIG. 2 illustrates an Internet-connected distributed computing system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

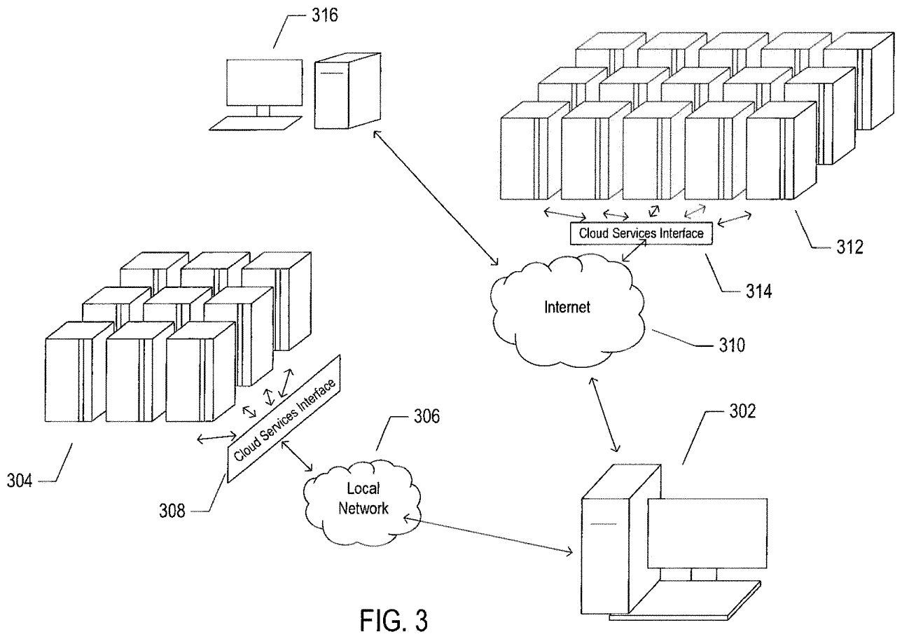

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

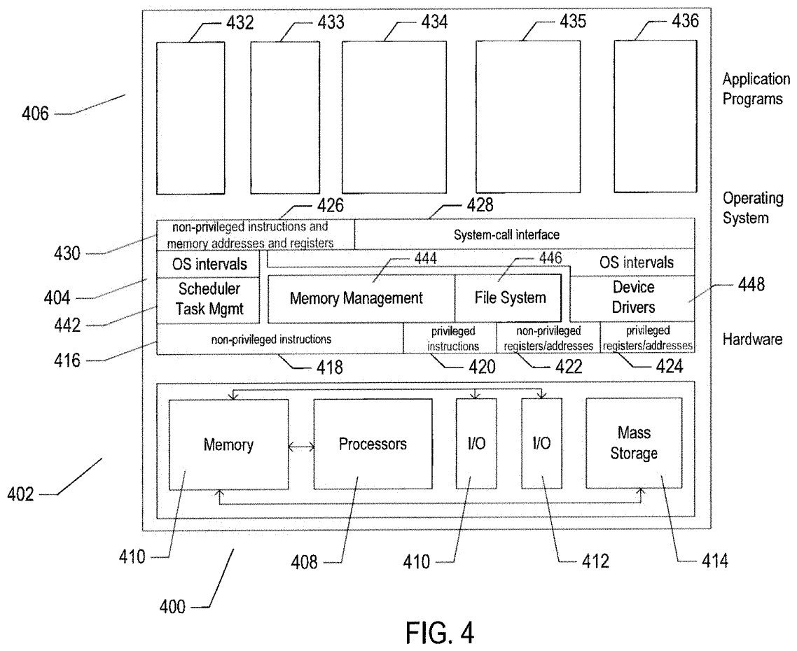

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computing system for high-availability, fault-tolerance, and load-balancing purposes. The problems are even greater in heterogeneous distributed computing systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

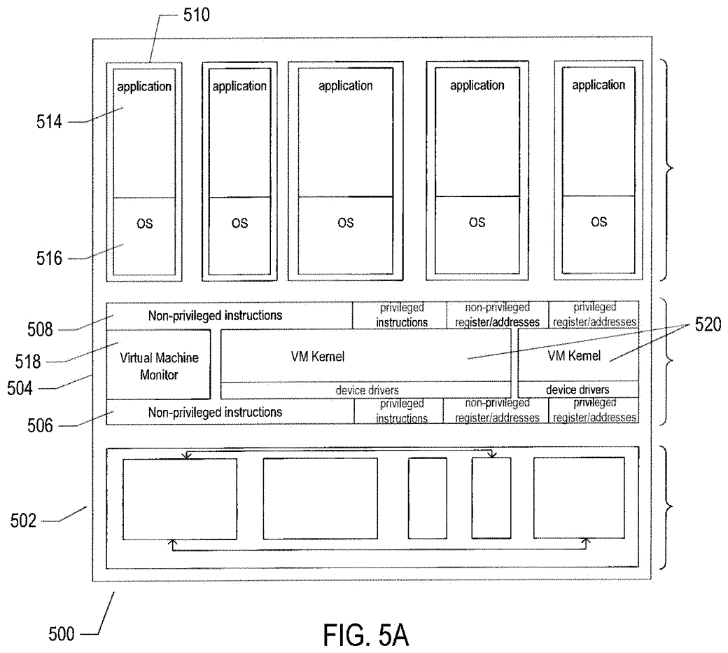

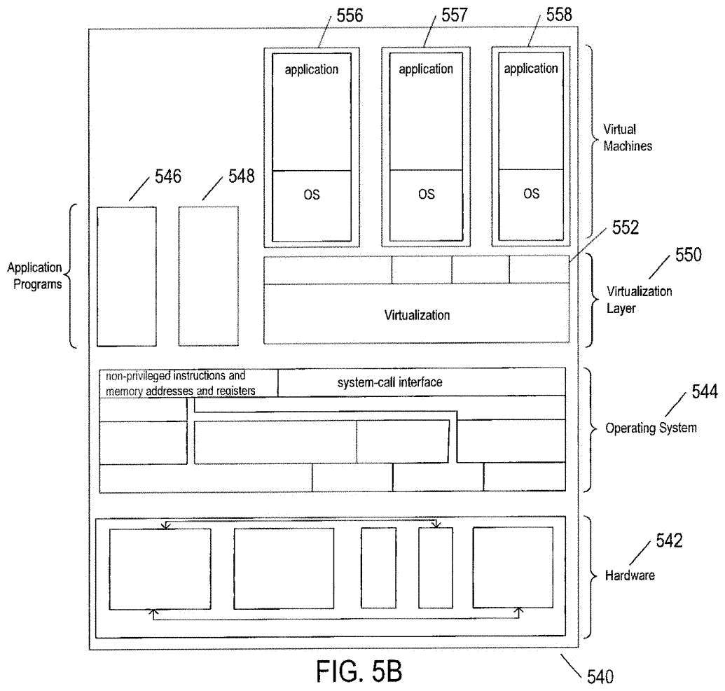

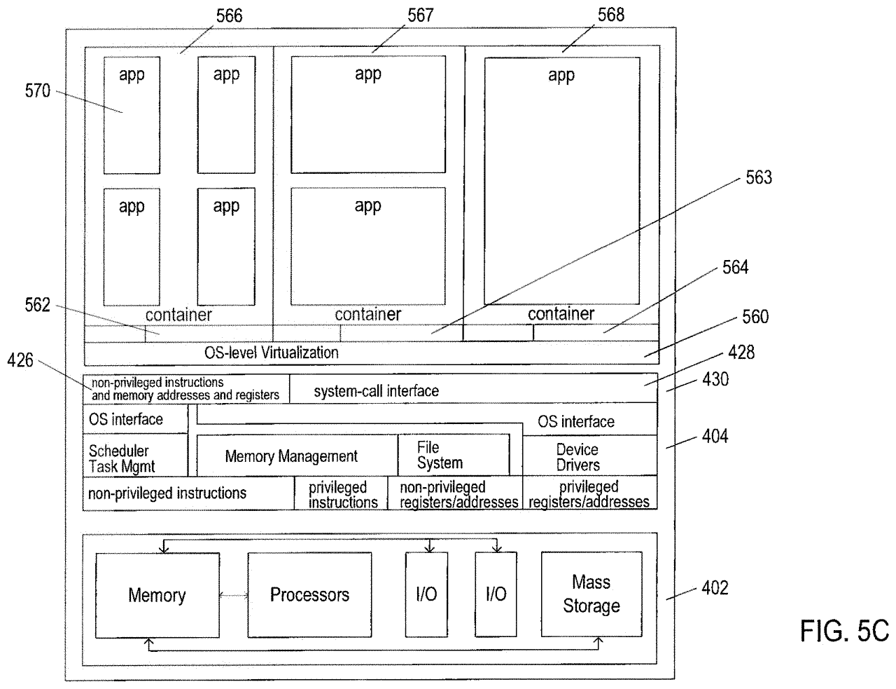

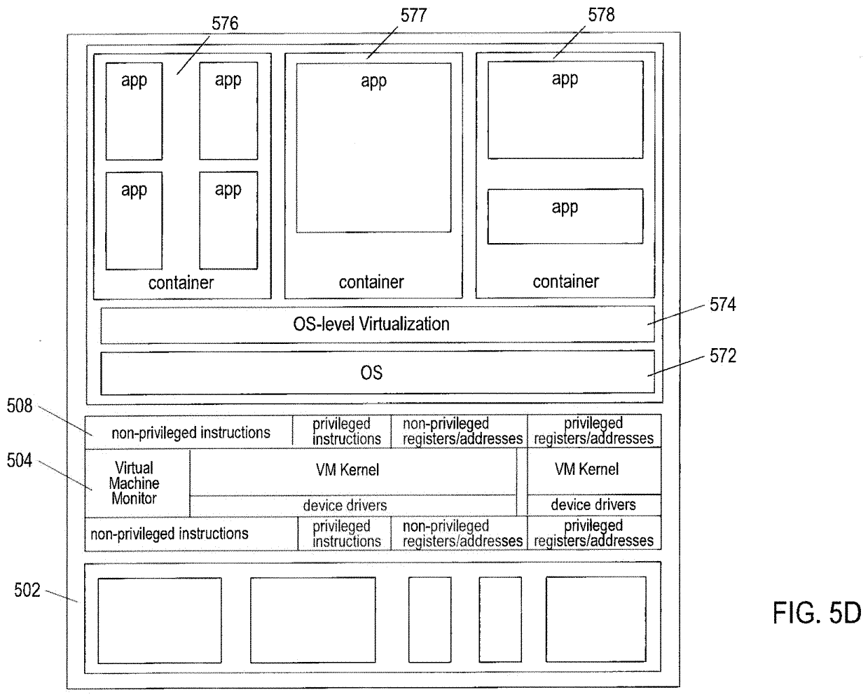

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-D illustrate several types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In Figure SB, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

While the traditional virtual-machine-based virtualization layers, described with reference to FIGS. 5A-B, have enjoyed widespread adoption and use in a variety of different environments, from personal computers to enormous distributed computing systems, traditional virtualization technologies are associated with computational overheads. While these computational overheads have been steadily decreased, over the years, and often represent ten percent or less of the total computational bandwidth consumed by an application running in a virtualized environment, traditional virtualization technologies nonetheless involve computational costs in return for the power and flexibility that they provide. Another approach to virtualization is referred to as operating-system-level virtualization (“OSL virtualization”). FIG. 5C illustrates the OSL-virtualization approach. In FIG. 5C, as in previously discussed FIG. 4, an operating system 404 runs above the hardware 402 of a host computer. The operating system provides an interface for higher-level computational entities, the interface including a system-call interface 428 and exposure to the non-privileged instructions and memory addresses and registers 426 of the hardware layer 402. However, unlike in FIG. 5A, rather than applications running directly above the operating system, OSL virtualization involves an OS-level virtualization layer 560 that provides an operating-system interface 562-564 to each of one or more containers 566-568. The containers, in turn, provide an execution environment for one or more applications, such as application 570 running within the execution environment provided by container 566. The container can be thought of as a partition of the resources generally available to higher-level computational entities through the operating system interface 430. While a traditional virtualization layer can simulate the hardware interface expected by any of many different operating systems. OSL virtualization essentially provides a secure partition of the execution environment provided by a particular operating system. As one example, OSL virtualization provides a file system to each container, but the file system provided to the container is essentially a view of a partition of the general file system provided by the underlying operating system. In essence, OSL virtualization uses operating-system features, such as name space support, to isolate each container from the remaining containers so that the applications executing within the execution environment provided by a container are isolated from applications executing within the execution environments provided by all other containers. As a result, a container can be booted up much faster than a virtual machine, since the container uses operating-system-kernel features that are already available within the host computer. Furthermore, the containers share computational bandwidth, memory, network bandwidth, and other computational resources provided by the operating system, without resource overhead allocated to virtual machines and virtualization layers. Again, however, OSL virtualization does not provide many desirable features of traditional virtualization. As mentioned above, OSL virtualization does not provide a way to run different types of operating systems for different groups of containers within the same host system, nor does OSL-virtualization provide for live migration of containers between host computers, as does traditional virtualization technologies.

FIG. 5D illustrates an approach to combining the power and flexibility of traditional virtualization with the advantages of OSL virtualization. FIG. 5D shows a host computer similar to that shown in FIG. 5A, discussed above. The host computer includes a hardware layer 502 and a virtualization layer 504 that provides a simulated hardware interface 508 to an operating system 572. Unlike in FIG. 5A, the operating system interfaces to an OSL-virtualization layer 574 that provides container execution environments 576-578 to multiple application programs. Running containers above a guest operating system within a virtualized host computer provides many of the advantages of traditional virtualization and OSL virtualization. Containers can be quickly booted in order to provide additional execution environments and associated resources to new applications. The resources available to the guest operating system are efficiently partitioned among the containers provided by the OSL-virtualization layer 574. Many of the powerful and flexible features of the traditional virtualization technology can be applied to containers running above guest operating systems including live migration from one host computer to another, various types of high-availability and distributed resource sharing, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides flexible and easy scaling and a simple approach to operating-system upgrades and patches. Thus, the use of OSL virtualization above traditional virtualization, as illustrated in FIG. 5D, provides much of the advantages of both a traditional virtualization layer and the advantages of OSL virtualization. Note that, although only a single guest operating system and OSL virtualization layer as shown in FIG. 5D, a single virtualized host system can run multiple different guest operating systems within multiple virtual machines, each of which supports one or more containers.

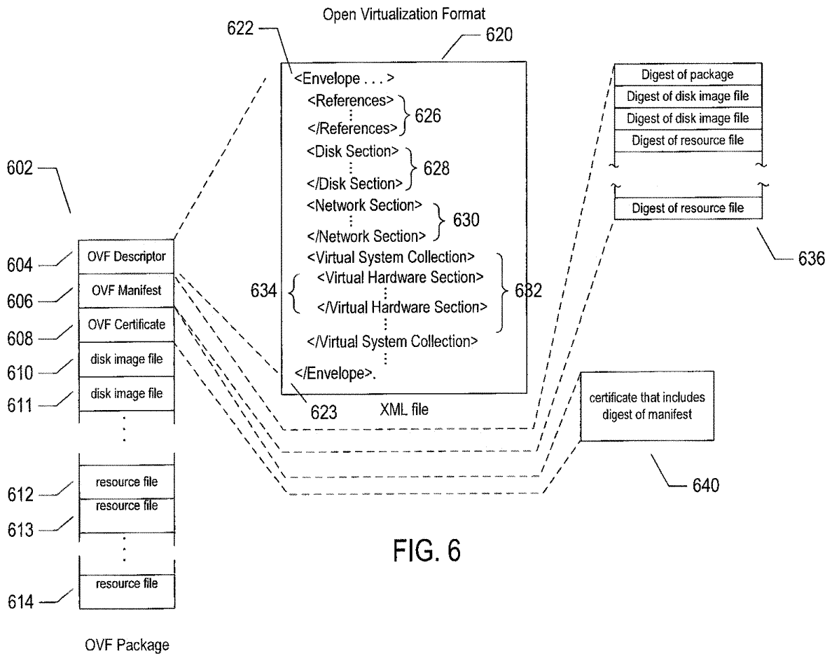

A virtual machine or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a virtual machine within one or more data files. FIG. 6 illustrates an OVF package. An OVF package 602 includes an OVF descriptor 604, an OVF manifest 606, an OVF certificate 608, one or more disk-image files 610-611, and one or more resource files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each virtual machine 634. There are many additional hierarchical levels and elements within a typical OVF descriptor. The OVF descriptor is thus a self-describing XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and resource files 612 are digitally encoded content, such as operating-s stem images. A virtual machine or a collection of virtual machines encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more virtual machines that is encoded within an OVF package.

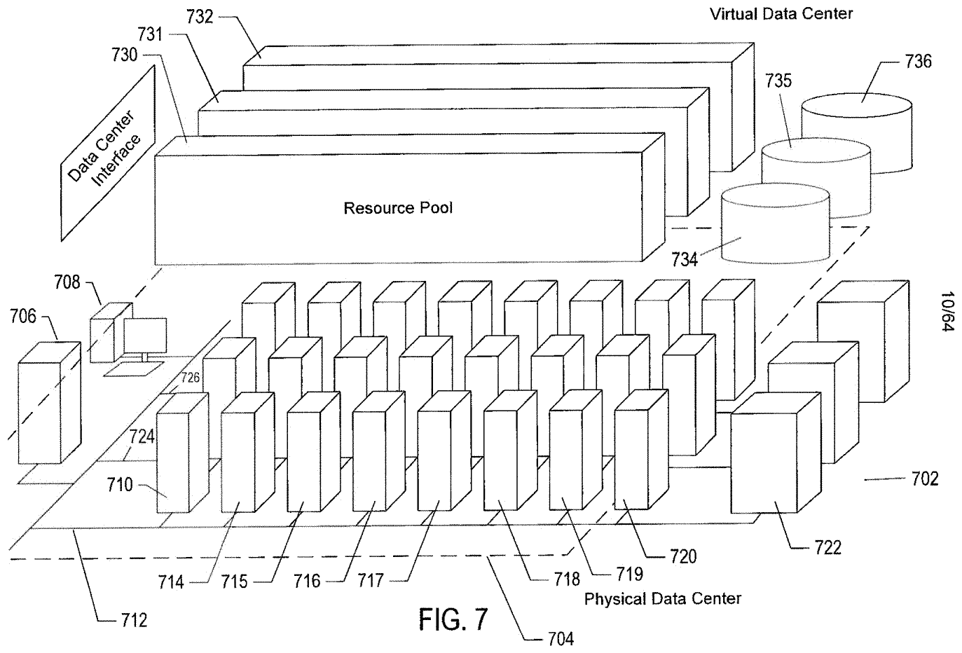

The advent of virtual machines and virtual environments has alleviated many of the difficulties and challenges associated with traditional general-purpose computing. Machine and operating-system dependencies can be significantly reduced or entirely eliminated by packaging applications and operating systems together as virtual machines and virtual appliances that execute within virtual environments provided by virtualization layers running on many different types of computer hardware. A next level of abstraction, referred to as virtual data centers which are one example of a broader virtual-infrastructure category, provide a data-center interface to virtual data centers computationally constructed within physical data centers. FIG. 7 illustrates virtual data centers provided as an abstraction of underlying physical-data-center hardware components. In FIG. 7, a physical data center 702 is shown below a virtual-interface plane 704. The physical data center consists of a virtual-infrastructure management server (“VI-management-server”) 706 and any of various different computers, such as PCs 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple virtual machines. Different physical data centers may include many different types of computers, networks, data-storage systems and devices connected according to many different types of connection topologies. The virtual-data-center abstraction layer 704, a logical abstraction layer shown by a plane in FIG. 7, abstracts the physical data center to a virtual data center comprising one or more resource pools, such as resource pools 730-732, one or more virtual data stores, such as virtual data stores 734-736, and one or more virtual networks. In certain implementations, the resource pools abstract banks of physical servers directly interconnected by a local area network.

The virtual-data-center management interface allows provisioning and launching of virtual machines with respect to resource pools, virtual data stores, and virtual networks, so that virtual-data-center administrators need not be concerned with the identities of physical-data-center components used to execute particular virtual machines. Furthermore, the VI-management-server includes functionality to migrate running virtual machines from one physical server to another in order to optimally or near optimally manage resource allocation, provide fault tolerance, and high availability by migrating virtual machines to most effectively utilize underlying physical hardware resources, to replace virtual machines disabled by physical hardware problems and failures, and to ensure that multiple virtual machines supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of virtual machines and virtual appliances as well as to provide high-level, distributed functionalities that involve pooling the resources of individual physical servers and migrating virtual machines among physical servers to achieve load balancing, fault tolerance, and high availability.

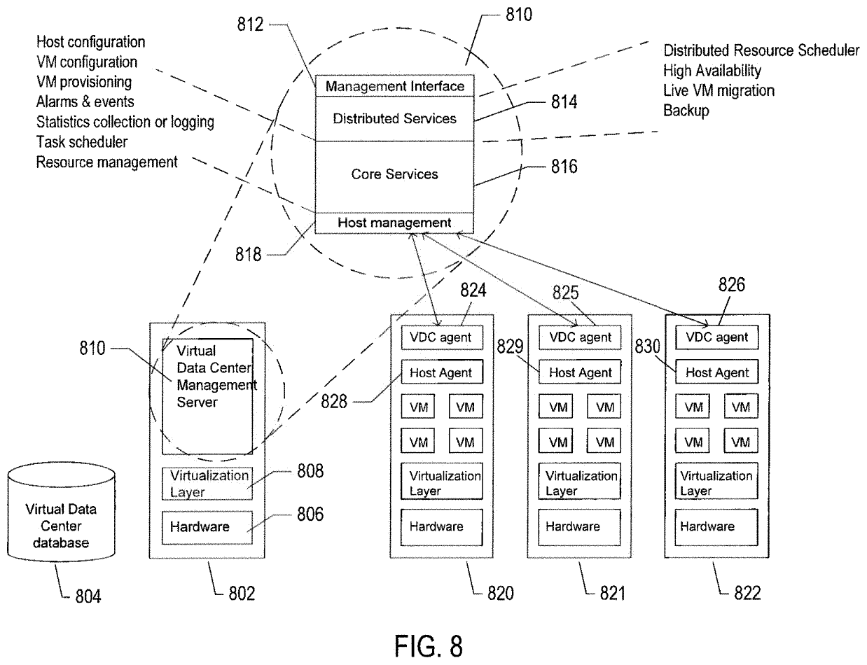

FIG. 8 illustrates virtual-machine components of a VI-management-server and physical servers of a physical data center above which a virtual-data-center interface is provided by the VI-management-server. The VI-management-server 802 and a virtual-data-center database 804 comprise the physical components of the management component of the virtual data center. The VI-management-server 802 includes a hardware layer 806 and virtualization layer 808 and runs a virtual-data-center management-server virtual machine 810 above the virtualization layer. Although shown as a single server in FIG. 8, the VI-management-server (“VI management server”) may include two or more physical server computers that support multiple VI-management-server virtual appliances. The virtual machine 810 includes a management-interface component 812, distributed services 814, core services 816, and a host-management interface 818. The management interface is accessed from any of various computers, such as the PC 708 shown in FIG. 7. The management interface allows the virtual-data-center administrator to configure a virtual data center, provision virtual machines, collect statistics and view log files for the virtual data center, and to carry out other, similar management tasks. The host-management interface 818 interfaces to virtual-data-center agents 824, 825, and 826 that execute as virtual machines within each of the physical servers of the physical data center that is abstracted to a virtual data center by the VI management server.

The distributed services 814 include a distributed-resource scheduler that assigns virtual machines to execute within particular physical servers and that migrates virtual machines in order to most effectively make use of computational bandwidths, data-storage capacities, and network capacities of the physical data center. The distributed services further include a high-availability service that replicates and migrates virtual machines in order to ensure that virtual machines continue to execute despite problems and failures experienced by physical hardware components. The distributed services also include a live-virtual-machine migration service that temporarily halts execution of a virtual machine, encapsulates the virtual machine in an OVF package, transmits the OVF package to a different physical server, and restarts the virtual machine on the different physical server from a virtual-machine state recorded when execution of the virtual machine was halted. The distributed services also include a distributed backup service that provides centralized virtual-machine backup and restore.

The core services provided by the VI management server include host configuration, virtual-machine configuration, virtual-machine provisioning, generation of virtual-data-center alarms and events, ongoing event logging and statistics collection, a task scheduler, and a resource-management module. Each physical server 820-822 also includes a host-agent virtual machine 828-830 through which the virtualization layer can be accessed via a virtual-infrastructure application programming interface (“API”). This interface allows a remote administrator or user to manage an individual server through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server. The virtual-data-center agents relay and enforce resource allocations made by the VI management server, relay virtual-machine provisioning and configuration-change commands to host agents, monitor and collect performance statistics, alarms, and events communicated to the virtual-data-center agents by the local host agents through the interface API, and to carry out other, similar virtual-data-management tasks.

The virtual-data-center abstraction provides a convenient and efficient level of abstraction for exposing the computational resources of a cloud-computing facility to cloud-computing-infrastructure users. A cloud-director management server exposes virtual resources of a cloud-computing facility to cloud-computing-infrastructure users. In addition, the cloud director introduces a multi-tenancy layer of abstraction, which partitions virtual data centers (“VDCs”) into tenant-associated VDCs that can each be allocated to a particular individual tenant or tenant organization, both referred to as a “tenant” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

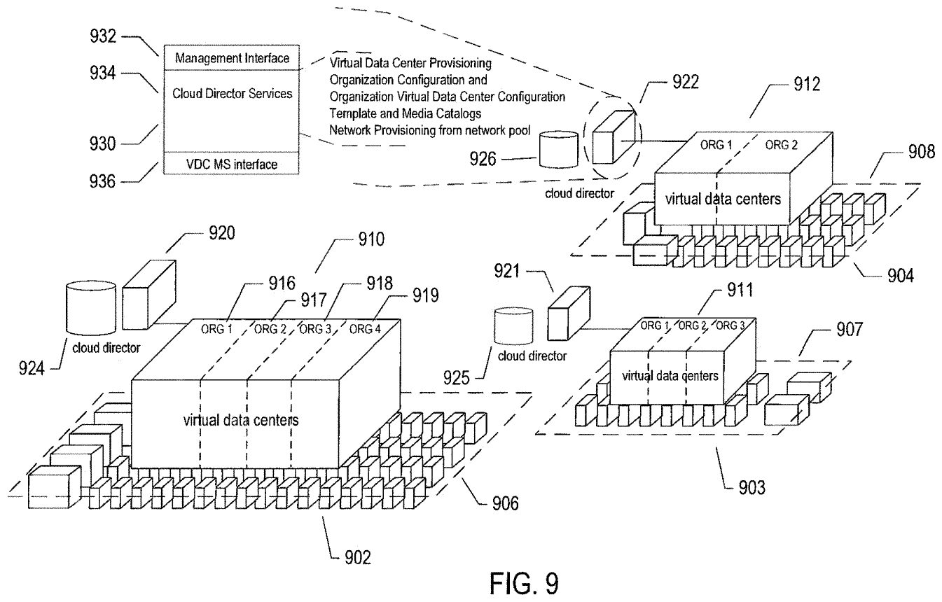

FIG. 9 illustrates a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The resources of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director servers 920-922 and associated cloud-director databases 924-926. Each cloud-director server or servers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are virtual machines that each contains an OS and/or one or more virtual machines containing applications. A template may include much of the detailed contents of virtual machines and virtual appliances that are encoded within OVF packages, so that the task of configuring a virtual machine or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VI management server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

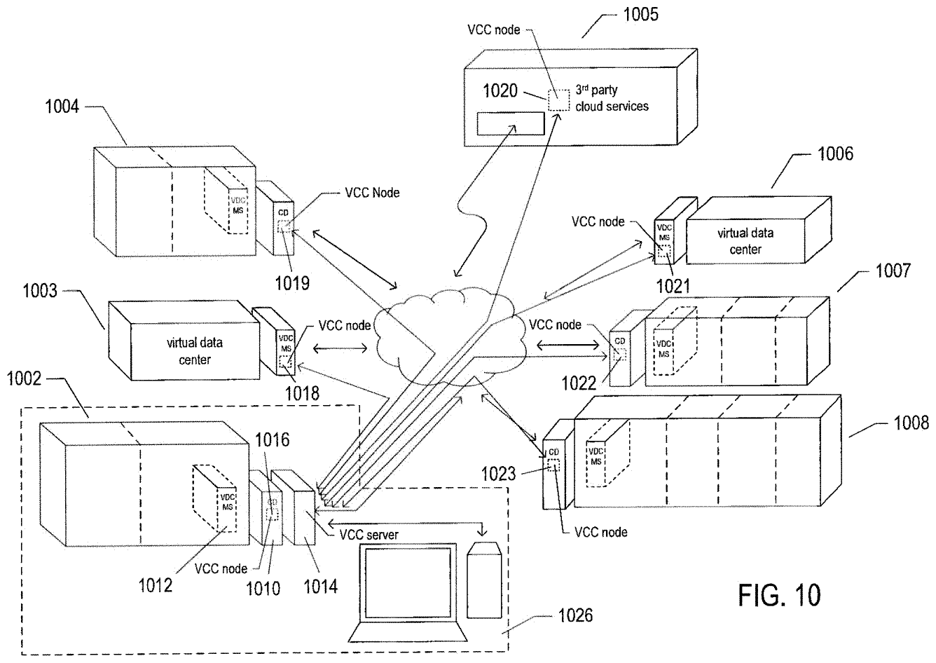

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are illustrated 1002-1008. Cloud-computing facility 1002 is a private multi-tenant cloud with a cloud director 1010 that interfaces to a VI management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VI management server that manages a single-tenant private cloud. The VCC server 1014 additionally interfaces, through the Internet, to VCC node virtual appliances executing within remote VI management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

### Log/Event-Message Systems

Modern distributed computing systems feature a variety of different types of automated and semi-automated administration and management systems that detect anomalous operating behaviors of various components of the distributed computing systems, collect errors reported by distributed-computing-system components, and use the detected anomalies and collected errors to monitor and diagnose the operational states of the distributed computing systems in order to automatically undertake corrective and ameliorative actions and to alert human system administrators of potential, incipient, and already occurring problems. Log/event-message reporting, collecting, storing, and querying systems are fundamental components of administration and management subsystems. The phrase “log/event message” refers to various types of generally short log messages and event messages issued by message-generation-and-reporting functionality incorporated within many hardware components, including network routers and bridges, network-attached storage devices, network-interface controllers, virtualization layers, operating systems, applications running within servers and other types of computer systems, and additional hardware devices incorporated within distributed computing systems. The log/event messages generally include both text and numeric values and represent various types of information, including notification of completed actions, errors, anomalous operating behaviors and conditions, various types of computational events, warnings, and other such information. The log/event messages are transmitted to message collectors, generally running within servers of local data centers, which forward collected log/event messages to message-ingestion-and-processing systems that collect and store log/event messages in message databases. Log/event-message query-processing systems provide, to administrators and managers of distributed computing systems, query-based access to log/event messages in message databases. The message-ingestion-and-processing systems may additionally provide a variety of different types of services, including automated generation of alerts, filtering, and other message-processing services.

Large modern distributed computing systems may generate enormous volumes of log/event messages, from tens of gigabytes (“GB”) to terabytes (“TB”) of log/event messages per day. Generation, transmission, and storage of such large volumes of data represent significant networking-bandwidth, processor-bandwidth, and data-storage overheads for distributed computing systems, significantly decreasing the available networking bandwidth, processor bandwidth, and data-storage capacity for supporting client applications and services. In addition, the enormous volumes of log/event messages generated, transmitted, and stored on a daily basis result in significant transmission and processing latencies, as a result of which greater than desired latencies in alert generation and processing of inquiries directed to stored log/event messages are often experienced by automated and semi-automated administration tools and services as well as by human administrators and managers.

FIG. 11 shows a small, 11-entry portion of a log file from a distributed computer system. A log file may store log/event messages for archival purposes, in preparation for transmission and forwarding to processing systems, or for batch entry into a log/event-message database. In FIG. 11, each rectangular cell, such as rectangular cell 1102, of the portion of the log file 1104 represents a single stored log/event message. In general, log/event messages are relatively cryptic, including only one or two natural-language sentences or phrases as well as various types of file names, path names, network addresses, component identifiers, and, other alphanumeric parameters. For example, log entry 1102 includes a short natural-language phrase 1106, date 1108 and time 1110 parameters, as well as a numeric parameter 1112 which appears to identify a particular host computer.

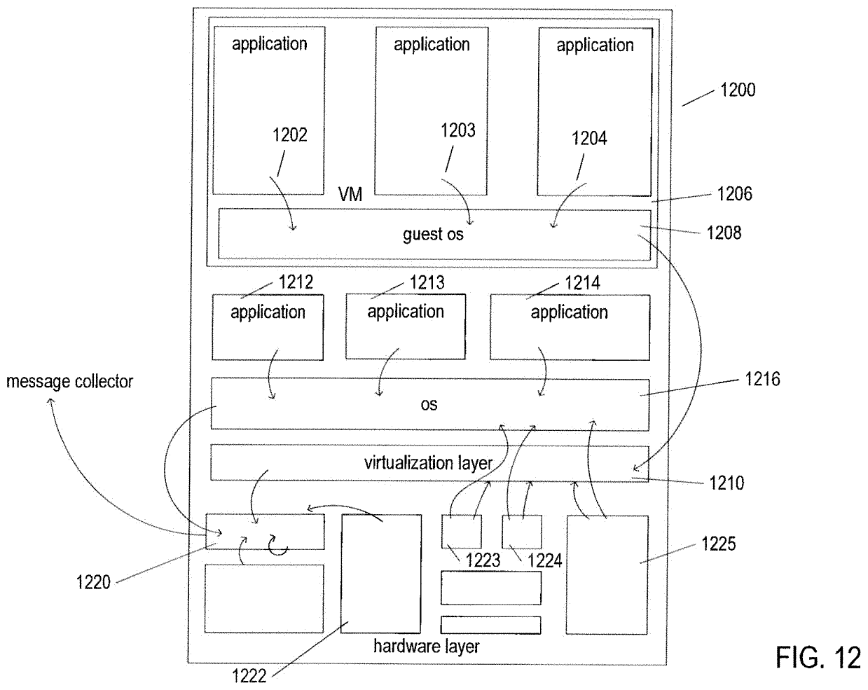

FIG. 12 illustrates generation of log/event messages within a server. A block diagram of a server 1200 is shown in FIG. 12. Log/event messages can be generated within application programs, as indicated by arrows 1202-1204. In this example, the log/event messages generated by applications running within an execution environment provided by a virtual machine 1206 are reported to a guest operating system 1208 running within the virtual machine. The application-generated log/event messages and log/event messages generated by the guest operating system are, in this example, reported to a virtualization layer 1210. Log event messages may also be generated by applications 1212-1214 running in an execution environment provided by an operating system 1216 executing independently of a virtualization layer. Both the operating system 1216 and the virtualization layer 1210 may generate additional log/event messages and transmit those log/event messages along with log/event messages received from applications and the guest operating system through a network interface controller 1222 to a message collector. In addition, various hardware components and devices within the server 1222-1225 may generate and send log/event messages either to the operating system 1216 and/or virtualization layer 1210, or directly to the network interface controller 122 for transmission to the message collector. Thus, many different types of log/event messages may be generated and sent to a message collector from many different components of many different component levels within a server computer or other distributed-computer-system components, such as network-attached storage devices, networking devices, and other distributed-computer-system components.

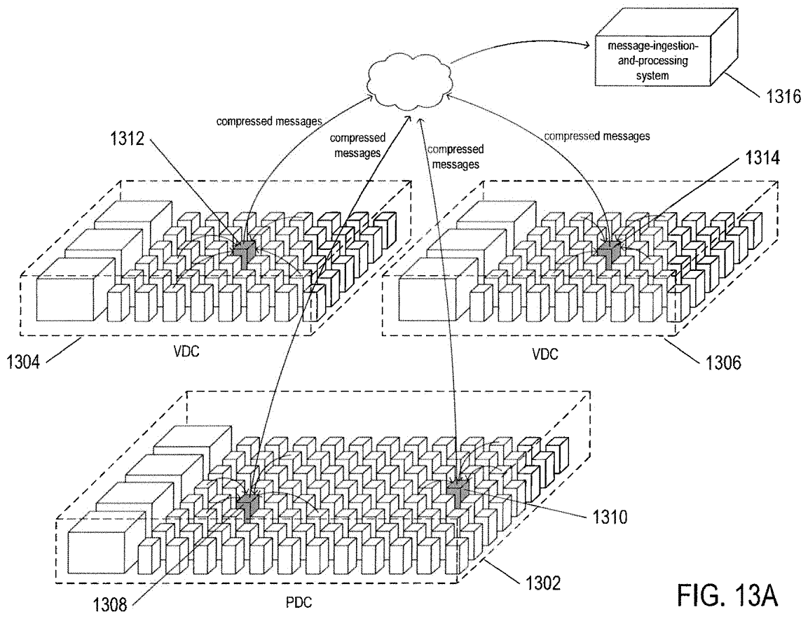

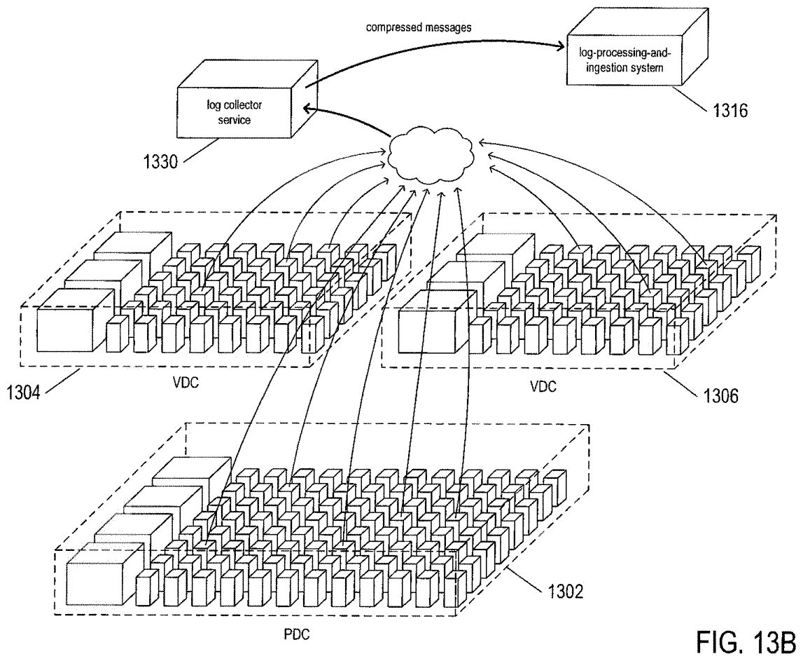

FIGS. 13A-B illustrate two different types of log/event-message collection and forwarding within distributed computer systems. FIG. 13A shows a distributed computing system comprising a physical data center 1302 above which two different virtual data centers 1304 and 1306 are implemented. The physical data center includes two message collectors running within two physical servers 1308 and 1310. Each virtual data center includes a message collector running within a virtual server 1312 and 1314. The message collectors compress batches of the collected messages and forward the compressed messages to a message-processing-and-ingestion system 1316. In certain cases, each distributed computing facility owned and/or managed by a particular organization may include one or more message-processing-and-ingestion systems dedicated to collection and storage of log/event messages for the organization. In other cases, they message-processing-and-ingestion system may provide log/event-message collection and storage for multiple distributed computing facilities owned and managed by multiple different organizations. In this example, log/event messages may be produced and reported both from the physical data center as well as from the higher-level virtual data centers implemented above the physical data center. In alternative schemes, message collectors within a distributed computing system may collect log/event messages generated both at the physical and virtual levels.

FIG. 13B shows the same distributed computing system 1302, 1304, and 1306 shown in FIG. 13A. However, in the log/event-message reporting scheme illustrated in FIG. 13B, log/event messages are collected by a remote message-collector service 1330 which then forwards the collected log/event messages to the message-processing-and-ingestion system 1316.

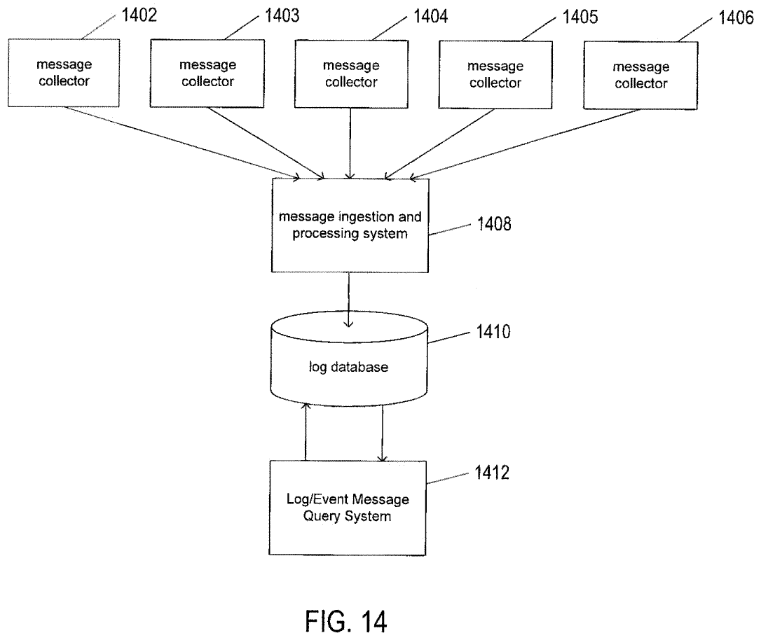

FIG. 14 provides a block diagram of a generalized log/event-message system incorporated within one or more distributed computing systems. The message collectors 1402-1406 receive log/event messages from log/event-message sources, including hardware devices, operating systems, virtualization layers, guest operating systems, and applications, among other types of log/event-message sources. The message collectors generally accumulate a number of log/event messages, compress them using any of commonly available data-compression methods, and send the compressed batches of log/event messages to a message-ingestion-and-processing system 1408. The message-ingestion-and-processing system decompresses received batches of messages, carry out any of various types of message processing, such as generating alerts for particular types of messages, filtering the messages, and normalizing the messages, prior to storing some or all of the messages in a message database 1410. A log/event-message query-processing system 1412 receives queries from distributed-computer-system administrators and managers, as well as from automated administration-and-management systems, and accesses the message database 1410 to retrieve stored log/event messages and/or information extracted from log/event messages specified by the receive queries for return to the distributed-computer-system administrators and managers and automated administration-and-management systems.

As discussed above, enormous volumes of log/event messages are generated within modern distributed computing systems. As a result, message collectors are generally processor-bandwidth bound and network-bandwidth bound. The volume of log/event-message traffic can use a significant portion of the intra-system and inter-system networking bandwidth, decreasing the network bandwidth available to support client applications and data transfer between local applications as well as between local applications and remote computational entities. Loaded networks generally suffer significant message-transfer latencies, which can lead to significant latencies in processing log/event messages and generating alerts based on processed log/event messages and to delayed detection and diagnosis of potential and incipient operational anomalies within the distributed computing systems. Message collectors may use all or significant portion of the network bandwidth and computational bandwidth of one or more servers within a distributed computer system, lowering the available computational bandwidth for executing client applications and services. Message-ingestion-and-processing systems are associated with similar network-bandwidth and processor-bandwidth overheads, but also use large amounts of data-storage capacities within the computing systems in which they reside. Because of the volume of log/event-message data stored within the message database, many of the more complex types of queries executed by the log/event-message query system against the stored log/event-message data may be associated with significant latencies and very high computational overheads. As the number of components within distributed computing systems increases, the network, processor-bandwidth, and storage-capacity overheads can end up representing significant portions of the total network bandwidth, computational bandwidth, and storage capacity of the distributed computing systems that generate log/event messages.

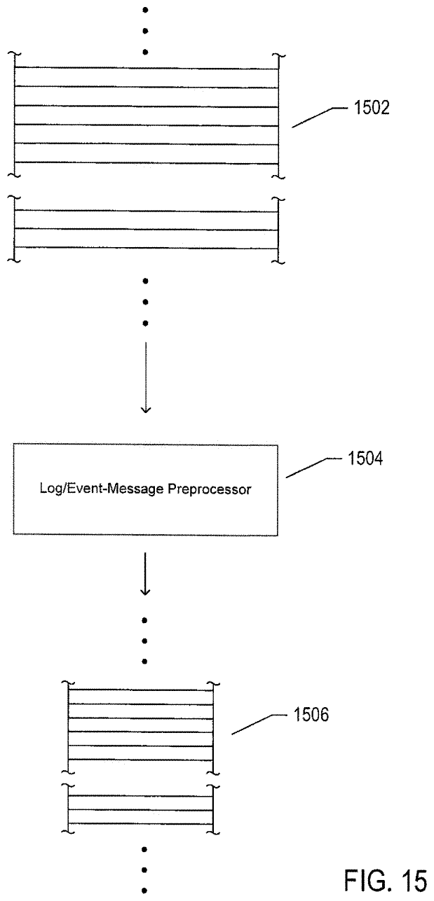

One approach to addressing the above-discussed problems is to attempt to preprocess log/event messages in ways that decrease the volume of data in a log/event-message stream. FIG. 15 illustrates log/event-message preprocessing. As shown in FIG. 15, an input stream of log/event messages 1502 is preprocessed by a log/event-message preprocessor 1504 to generate an output stream 1506 of log/event messages that represents a significantly smaller volume of data. Preprocessing may include filtering received to log/event messages, compressing received log/event messages, and applying other such operations to received log/event messages that result in a decrease in the data volume represented by the stream of log/event messages output from the preprocessing steps.

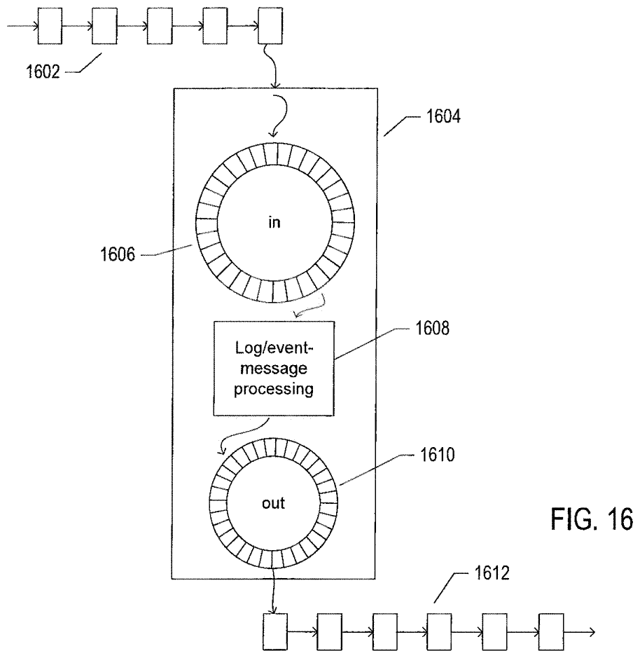

FIG. 16 illustrates processing of log/event messages by a message-collector system or a message-ingestion-and-processing system. An input stream of event log messages 1602 is received by data-transmission components of the system 1604 and placed in an in queue 1606. Log/event-message processing functionality 1608 processes log/event messages removed from the in queue and places resulting processed log/event messages for transmission to downstream processing components in an out queue 1610. Data-transmission components of the system remove processed log/event messages from the out queue and transmit them via electronic communications to downstream processing components as an output log/event-message stream 1612. Downstream components for message-collector systems primarily include message-ingestion-and-processing systems, but may include additional targets, or destinations, to which log/event-messages are forwarded or to which alerts and notifications are forwarded. Downstream components for message-ingestion-and-processing systems primarily include log/event-message query systems, which store log/event messages for subsequent retrieval by analytics systems and other log/event-message-consuming systems within a distributed computer system, but may also include additional targets, or destinations, to which log/event-messages are forwarded or to which alerts and notifications are forwarded as well as long-term archival systems.

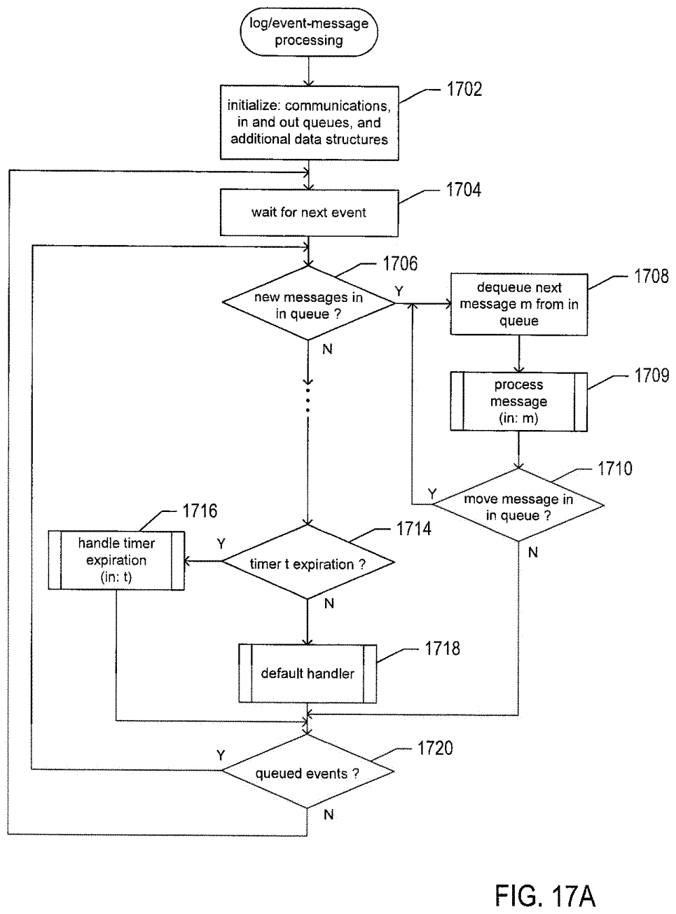

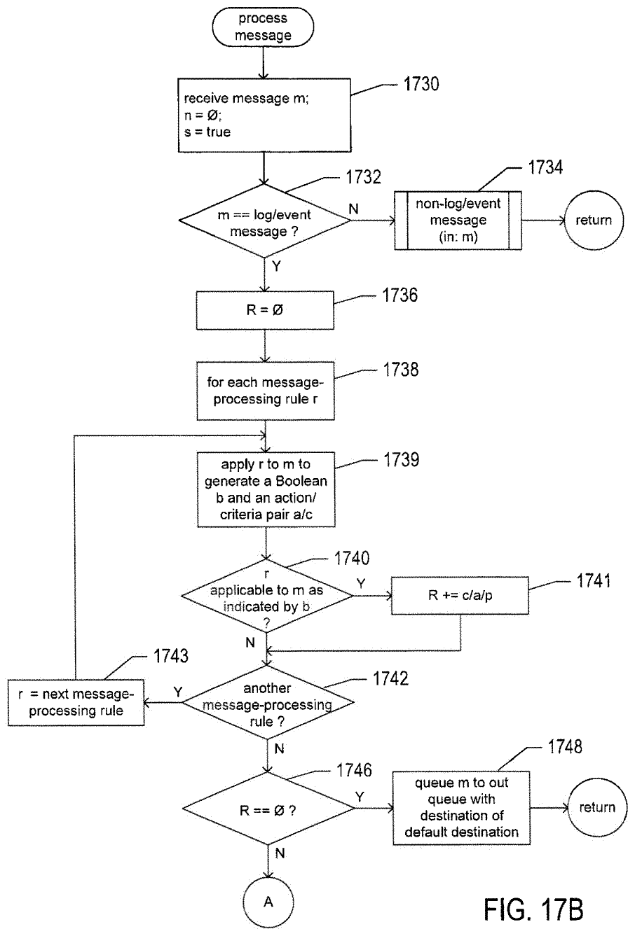

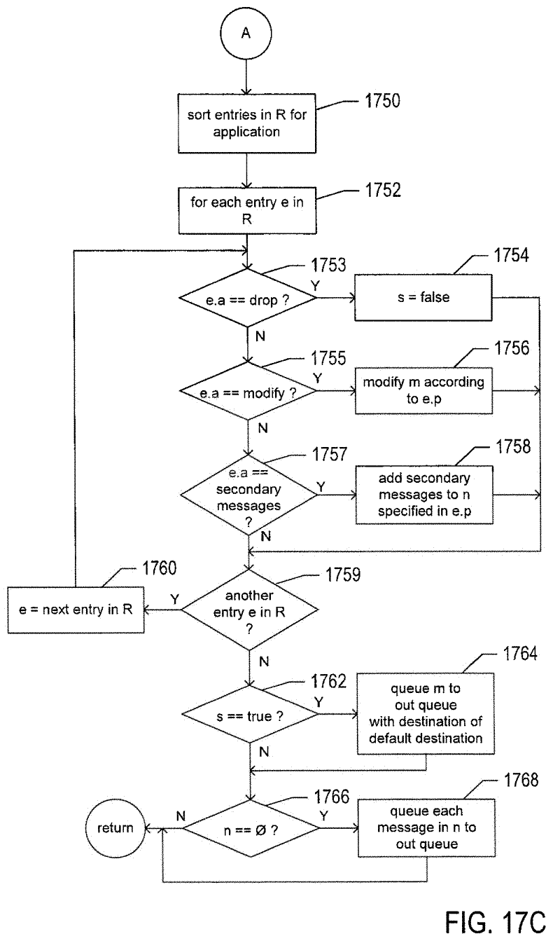

FIGS. 17A-C provide control-flow diagrams that illustrate log/event-message processing within currently available message-collector systems and message-ingestion-and-processing systems. FIG. 17A shows a highest-level control-flow diagram in which the log/event-message processing logic is represented as an event loop. In step 1702, log/event-message processing is initialized by initializing communications connections, through which log/event messages are received and to which processed log/event messages are output for transmission to downstream components, by initializing the in and out queues, and by initializing additional data structures. In step 1704, the log/event-message processing logic waits for a next event to occur. When a next event occurs, and when the next-occurring event is reception of one or more new messages, as determined in step 1706, messages are dequeued from the in queue and processed in the loop of steps 1708-1710. For each dequeued message, the routine “process message” is called in step 1709. Ellipsis 1712 indicates that there may be many additional types of events that are handled by the event loop shown in FIG. 17A. When the next-occurring event is a timer expiration, as determined in step 1714, a timer-expiration handler is called in step 1716. A default handler 1718 handles any rare or unexpected events. When there are more events queued for processing, as determined in step 1720, control returns to step 1706. Otherwise, control returns to step 1704, where the log/event-message-processing logic waits for the occurrence of a next event.

FIGS. 17B-C provide a control-flow diagram for the routine “process message” called in step 1709 of FIG. 17A. In step 1730, the routine “process message” receives a message m, sets a set variable n to null, and sets a Boolean variable s to TRUE. When the received message is not a log/event message, as determined in step 1732, a routine is called to process the non-log/event message, in step 1734, and the routine “process message” terminates. Processing of non-log/event messages is not further described. When the received message is a log/event message, as determined in step 1732, a set variable R is set to null, in step 1736. In the for-loop of steps 1738-1743, the routine “process message” attempts to apply each rule r of a set of processing rules to the received message to determine whether or not the rule r applies to the message. When the currently considered processing rule r is applicable to the message, as determined in steps 1739 and 1740, the rule is added to the set of rules contained in the set variable R, in step 1741. As discussed below, a processing rule consists of a Boolean expression representing the criteria for applicability of the rule, c, an action a to be taken when the rule applies to a message, and any of various parameters p used for rule application. Thus, in step 1741, the rule added to the set of rules contained in set variable R is shown as the criteria/action/parameters triple c/a/p. When, following execution of the for-loop of steps 1738-1743, the set variable R contains no applicable rules, as determined in step 1746, the received message m is added to the out queue, in step 1748, for transmission to downstream processing components. Otherwise, the applicable rules are applied to the received message m as shown in FIG. 17C. First, the rules stored in set variable R are sorted into an appropriate rule sequence for application to the message, in step 1750. Sorting of the rules provides for message-processing efficiency and correctness. For example, if one of the applicable rules specifies that the message to be dropped, but another of the applicable rules specifies that a copy of the message needs to be forwarded to a specified target or destination, the rule that specifies forwarding of the copy of the message should be processed prior to processing the rule that specifies that the message is to be dropped, unless the latter rule is meant to exclude prior message forwarding. In the for-loop of steps 1752-1760, each rule of the sorted set of rules in the set variable R is applied to the received message m. When the currently considered rule indicates that the message should be dropped, as determined in step 1753, the local variable s is set to FALSE, in step 1754. When the currently considered rule indicates that the received message m needs to be modified, as determined in step 1755, the modification is carried out in step 1756. When the currently considered rule indicates that secondary messages, such as forwarded copies, notifications, or alerts should be transmitted to target destinations, as determined in step 1757, the secondary messages are generated and placed in the set variable n, in step 1758. Following completion of the for-loop of steps 1752-1760, when the local variable s has the value TRUE, as determined in step 1762, the received message m is queued to the out queue, and step 1764, for transmission to the default destination for messages for the system, such as a message-ingestion-and-processing system, in the case of a message collector system, or a log/event-message query system, in the case of a message-ingestion-and-processing system. When the local set variable n is not empty, as determined in step 1766, each secondary message contained in local set variable n is queued to the out queue for transmission, in step 1768.

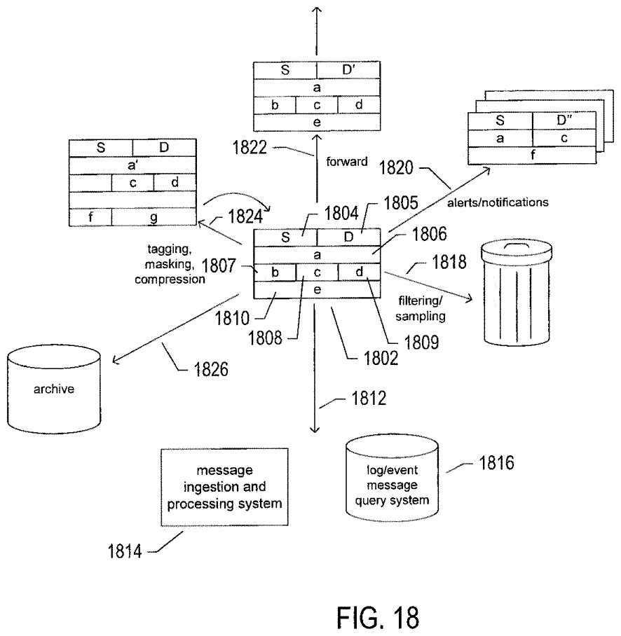

FIG. 18 illustrates various common types of initial log/event-message processing carried out by message-collector systems and/or message-ingestion-and-processing systems. A received log/event message 1802 is shown in the center of FIG. 18. In this example, the message contains source and destination addresses 1804-1805 in a message header as well as five variable fields 1806-1810 with field values indicated by the symbols “a,” “b.” “c,” “d,” and “e,” respectively. The message is generally transmitted to a downstream processing component, as represented by arrow 1812, where downstream processing components include a message-ingestion-and-processing system 1814 and a log/event-message query system 1860. Transmission of the message to a downstream processing component occurs unless a processing rule specifies that the transmission should not occur. Alternatively, the message may be dropped, as indicated by arrow 1818, due to a filtering or sampling action contained in a processing rule. Sampling involves processing only a specified percentage p of log/event messages of a particular type or class and dropping the remaining 1-p percentage of the log/event messages of the particular type or class. Filtering involves dropping, or discarding, those log/event messages that meet a specified criteria. Rules may specify that various types of alerts and notifications are to be generated, as a result of reception of a message to which the rule applies, for transmission to target destinations specified by the parameters of the rule, as indicated by arrow 1820. As indicated by arrow 1822, a received log/event message may be forwarded to a different or additional target destinations when indicated by the criteria associated with a processing rule. As indicated by arrow 1824, processing rules may specify that received log/event messages that meet specified criteria should be modified before subsequent processing steps. The modification may involve tagging, in which information is added to the message, masking, which involves altering field values within the message to prevent access to the original values during subsequent message processing, and compression, which may involve deleting or abbreviating fields within the received log/event message. Arrow 1826 indicates that a rule may specify that a received message is to be forwarded to a long-term archival system. These are but examples of various types of initial log/event-message processing steps that that may be carried out by message collectors and/or message-ingestion-and-processing systems when specified by applicable rules.

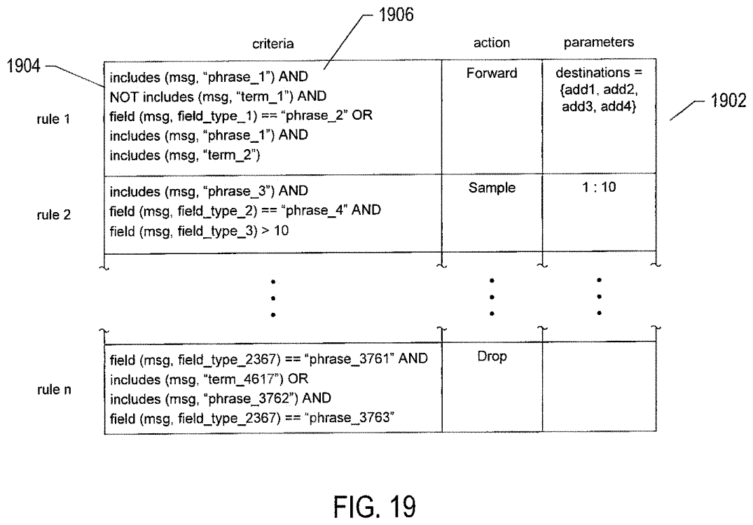

FIG. 19 illustrates processing rules that specify various types of initial log/event-message processing. The processing rules are contained in a table 1902 shown in FIG. 19. As discussed above, each rule comprises a Boolean expression that includes the criteria for rule applicability, an action, and parameters used for carrying out the actions. In the table 1902 shown in FIG. 19, each row of the table corresponds to a rule. A first, rule 1, 1904, is applied to a log/event message when application of the Boolean expression 1906 to the log/event message returns a value TRUE. This expression indicates that rule 1 is applicable to a log/event message msg when the message includes a first phrase phrase_1, does not include a first term term_1, and includes, as the value of a first field, a second phrase phrase_2 or when the message includes the first phrase phrase_1 as well as a second term term_2. When the criteria are met by a log/event message, the log/event message is specified, by the rule, to be forwarded to four destinations with addresses add1, add2, add3, and add4. The placeholders phrase_1, phrase_2, term_1, term_2, add1, add2, add3, and add4 in the expression stand for various particular character strings and/or alphanumeric strings. The rules shown in FIG. 19, of course, are only hypothetical examples of the types of log/event-message processing rules that might be employed by initial-log/event-message-processing logic within message collectors and message-ingestion-and-processing systems.

While use of message-processing rules provides for flexible implementation and control of initial message processing by message collectors and message-ingestion-and-processing systems, message-processing-rule-based implementations are associated with many serious problems in current log/event-message systems. One problem is that there may be a huge number of different types of log/event messages that may be generated and collected within a distributed computer system, from hundreds, thousands, to many thousands of different log/event-message types. Specifying rules for initial log/event-message processing may therefore involve constructing thousands, tens of thousands, or more rules, which is generally infeasible or practically impossible. Another problem is that, in current systems, determination of whether a particular message-processing rule is applicable to a particular log/event message involves computationally intensive, character-by-character log/event-message-processing to match term-and-phrase literals or placeholders in the Boolean criteria expression of a message-processing rule to terms and phrases in the log/event message. As discussed above, message collectors and message-ingestion-and-processing systems are often hard-pressed to keep up with the volume of log/event messages generated within a distributed computing system, and any unnecessary computational overheads involved in initial log/event-message processing can result in log/event messages being discarded or dropped because of the lack of computational bandwidth for processing the log/event messages. When message-processing rules are manually specified, and even when message-processing rules are programmatically generated, the probability that human error will result in incorrect messages that lead to faulty message processing is quite high.

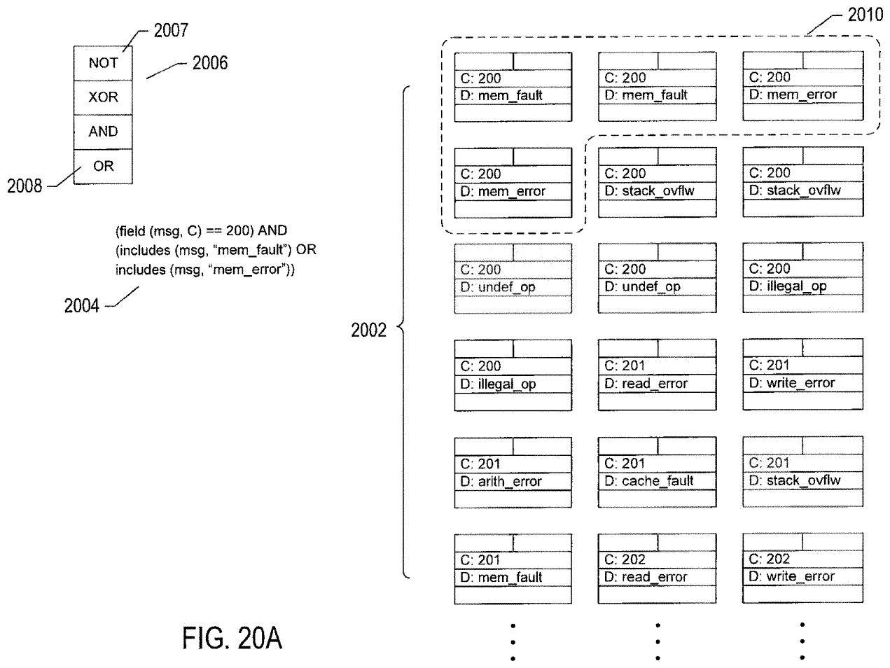

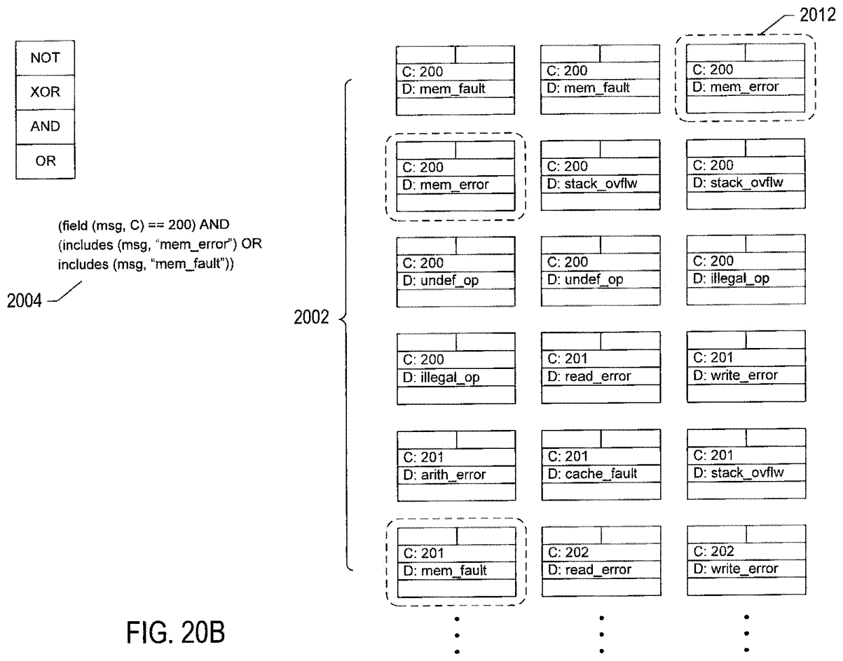

FIGS. 20A-B provide a simple example of the types of errors that may be encountered when message-processing rules are manually specified or programmatically generated. In FIG. 20A, a set of log/event messages 2002 is shown in the right-hand portion of the figure. Values are shown for two different fields C and D in each message. A hypothetical criteria for applicability of a rule is indicated by Boolean expression 2004. Boolean operators are each generally associated with a precedence, as indicated by the ordered vector of Boolean operators 2006. The Boolean operator NOT 2007 has the highest precedence and the Boolean operator OR 2008 as the lowest precedence. For clarity and to ensure lack of ambiguity, parentheses are used in Boolean expression 2004 to make it clear that the Boolean operator AND operates on a first sub-expression indicating that the value of field C must be equal to 200 and a second sub-expression indicating that the log/event message must include either the phrase “mem_fault” or the phrase “mem_error.” The log/event messages in the set of log/event messages which satisfy the criteria represented by Boolean expression 2004 are surrounded by the dashed curve 2010. As shown in FIG. 20B, where the sub-expression parentheses have been inadvertently omitted from criteria expression 2004, the meaning of the criteria expression is changed, because the AND operator has higher precedence than OR, and now specifies that for the rule to be applicable to a log/event message, the field C must have a value of 200 and the message must contain the phrase “mem_error” or, alternatively, the message must contain the phrase “mem_fault.” The messages in the set of messages 2002 for which the criteria expression shown in FIG. 20B returns the value TRUE are surrounded by dashed curves, such as dashed curve 2012 in FIG. 20B. The messages for which the criteria expression without sub-expression parentheses evaluates to TRUE can be seen to be quite different than the messages for which the criteria expression shown in FIG. 20A returns the value TRUE. This type of error is common, both for human rule constructors as well as for human programmers. There are many other types of examples of common errors that can drastically alter the set of log/event messages to which an improperly specified rule applies.

Because of the many problems associated with message-processing rules, message-processing rules tend not to be used to the extent that they could be used for control of log/event-message systems. As a result, log/event-message systems often fail to carry out many of the initial-log/event-message-processing steps that would increase the efficiency of log/event-message systems and that would provide fine-grain control of log/event-message systems to facilitate desired distributed-computer-system management-and-administration operations and tasks.

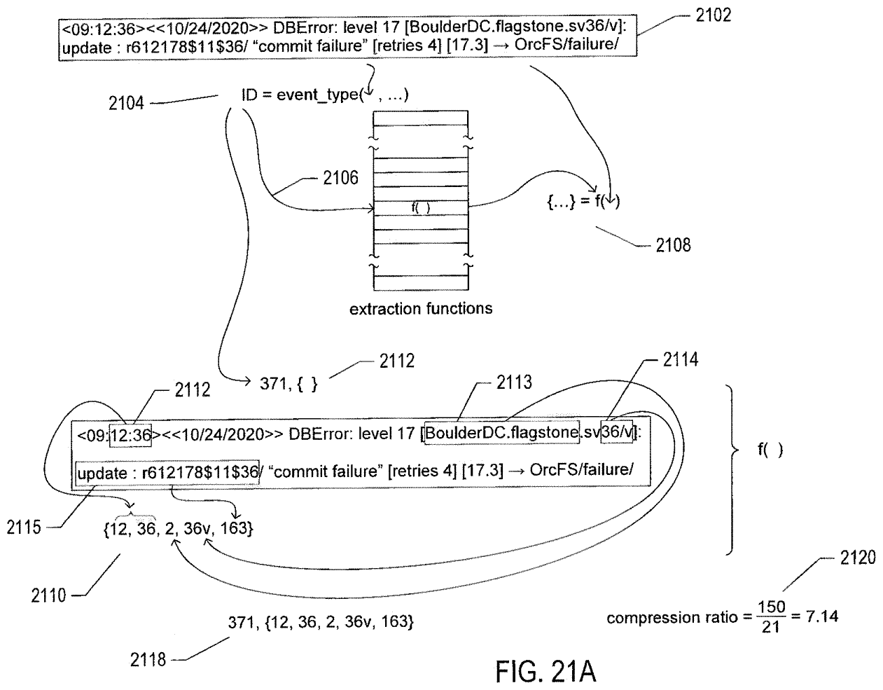

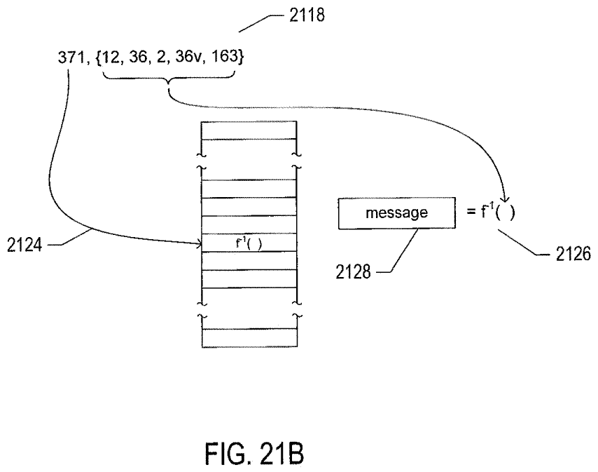

FIGS. 21A-B illustrate a log/event-message-type generation method. A hypothetical log/event message 2102 is shown at the top of FIG. 21A. As is typical for log/event messages, log/event message 2102 includes numerous formatted fields and phrases with significant meanings that cannot be discerned from the contents of the log/event message, alone. Either by automated, semi-automated, or manual means, a log/event message can be processed to determine a message type, referred to below as an “event type,” corresponding to the message and to determine a list of numeric values and/or character strings that correspond to variables within a log/event message. In other words, log/event messages are associated with types and log/event messages contain static and relatively static portions with low information content and variable portions with high information content. As shown in FIG. 21 A, log/event message 2102 can be automatically processed 2104 to generate an event type, referred to as “ID” in FIGS. 21A-B. This processing is encapsulated in the function event_type( ). Implementation of the function event_type( ) can vary, depending on the distributed computing systems that generate the log/error messages. In certain cases, relatively simple pattern-matching techniques can be used, along with regular expressions, to determine the event type for a given log/error message. In other implementations, a rule-based system or a machine-learning system, such as a neural network, can be used to generate an event type for each log/error message and/or parse the log error message. In certain cases, the event type may be extracted from an event-type field of event messages as a numerical or character-string value. The event type can then be used, as indicated by curved arrow 2106 in FIG. 21A, to select a parsing function ƒ( ) for the event type that can be used to extract the high-information-content, variable values from the log/event message 2108. The extracted variable values are represented, in FIG. 21A and subsequent figures, by the notation “{ . . . },” or by a list of specific values within curly brackets, such as the list of specific values “{12, 36, 2, 36v, 163}” 2110 shown in FIG. 21A. As a result, each log/event message can be alternatively represented as a numerical event type, or identifier, and a list of 0, 1, or more extracted numerical and/or character-string values 2112. In the lower portion of FIG. 21A, parsing of log/event message 2102 by a selected parsing or extraction function ƒ( ) is shown. The high-information variable portions of the log/event message are shown within rectangles 2112-2115. These portions of the log/event message are then extracted and transformed into the list of specific values “{12, 36, 2, 36v, 163}” 2110. Thus, the final form of log/event message 2102 is an ID and a compact list of numeric and character-string values 2118, referred to as an “event tuple.” As shown in FIG. 21B, there exists an inverse process for generating the original log/error message from the expression 2118 obtained by the compression process discussed above with reference to FIG. 21A. The event type, or ID, is used to select, as indicated by curved arrow 2124, a message-restoration function ƒ¹( ) which can be applied 2126 to the expression 2118 obtained by the event-tuple-generation process to generate the original message 2128. In certain implementations, the decompressed, or restored, message may not exactly correspond to the original log/event message, but may contain sufficient information for all administration/management needs. In other implementations, message restoration restores the exact same log/event message that was compressed by the process illustrated in FIG. 21A.

A variety of techniques and approaches to generating or implementing the above-discussed event_type( ) function and extraction and message-restoration functions ƒ( ) and ƒ¹( ) are possible. In certain cases, these functions can be prepared manually from a list of well-understood message types and message formats. Alternatively, these functions can be generated by automated techniques, including clustering techniques, or implemented by machine-learning techniques.

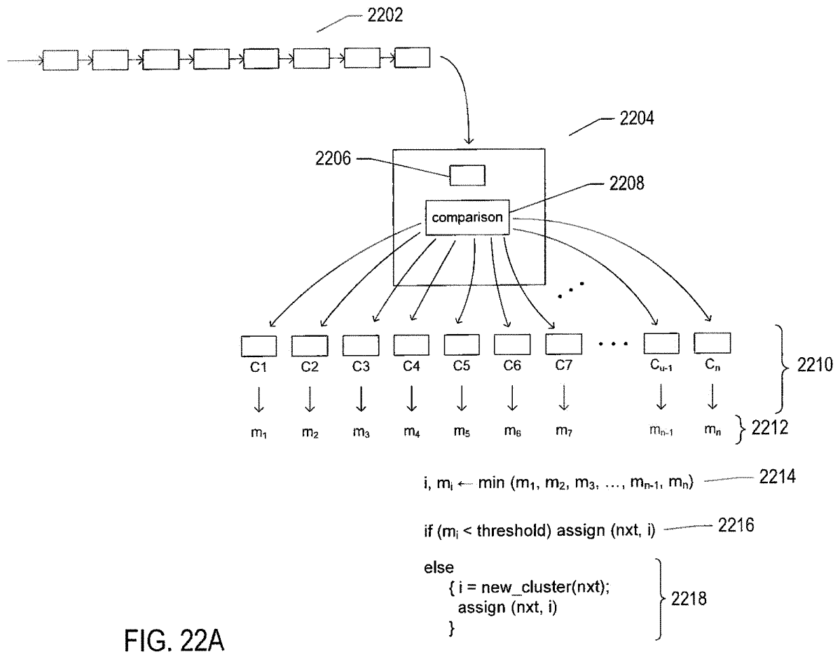

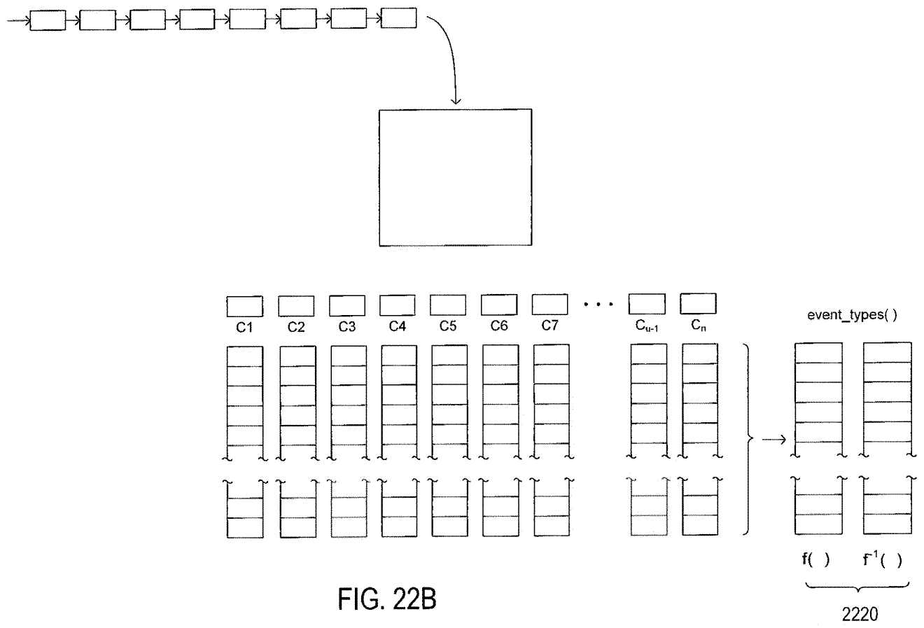

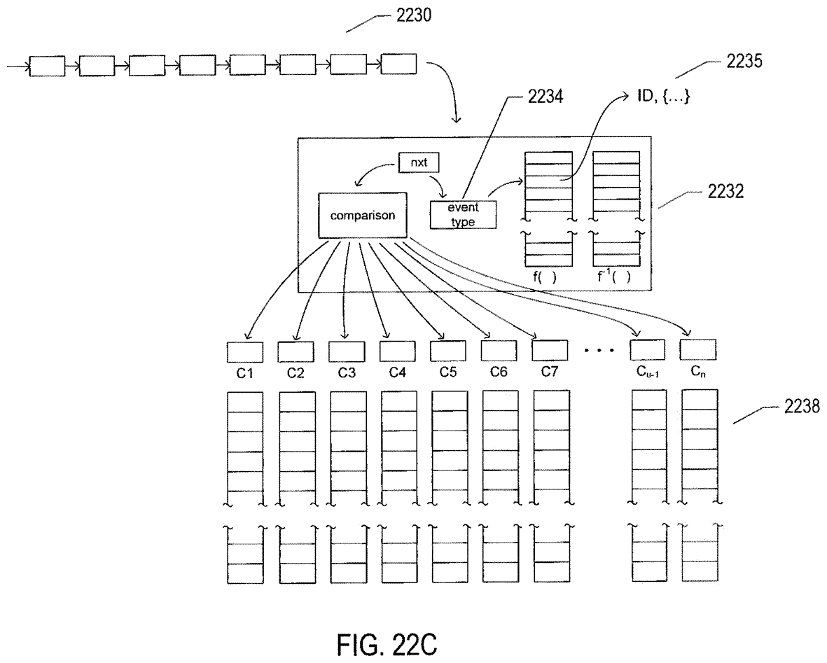

FIGS. 22A-C illustrate a clustering technique for generating an event_type( ) function and extraction and message-restoration functions ƒ( ) and ƒ¹( ).

As shown in FIG. 22A, incoming log/event messages 2202 are input sequentially to a clustering system 2204. Each message 2206 is compared, by a comparison function 2208, to prototype messages representative of all of the currently determined clusters 2210. Of course, initially, the very first log/event message becomes the prototype message for a first cluster. A best comparison metric and the associated cluster are selected from the comparison metrics 2212 generated by the comparison function 2214. An example shown in FIG. 22A, the best comparison metric is the metric with the lowest numerical value. In this case, when the best comparison metric is a value less than a threshold value, the log/event message 2206 is assigned to the cluster associated with the best comparison metric 2216. Otherwise, the log/event message is associated with the new cluster 2218. As shown in FIG. 22B, this process continues until there are sufficient number of log/event messages associated with each of the different determined clusters, and often until the rate of new-cluster identification falls below a threshold value, at which point the clustered log/event messages are used to generate sets of extraction and message-restoration functions ƒ( ) and ƒ¹( ) 2220. Thereafter, as shown in FIG. 22C, as new log/event messages 2230 are received, the fully functional clustering system 2232 generates the event-type/variable-portion-list expressions for the newly received log/event messages 2234-2235 using the current event_type( ) function and sets of extraction and message-restoration functions ƒ( ) and ƒ¹( ), but also continues to cluster a sampling of newly received log/event messages 2238 in order to dynamically maintain and evolve the set of clusters, the event_type( ) function, and the sets of extraction and message-restoration functions ƒ( ) and ƒ¹( ).

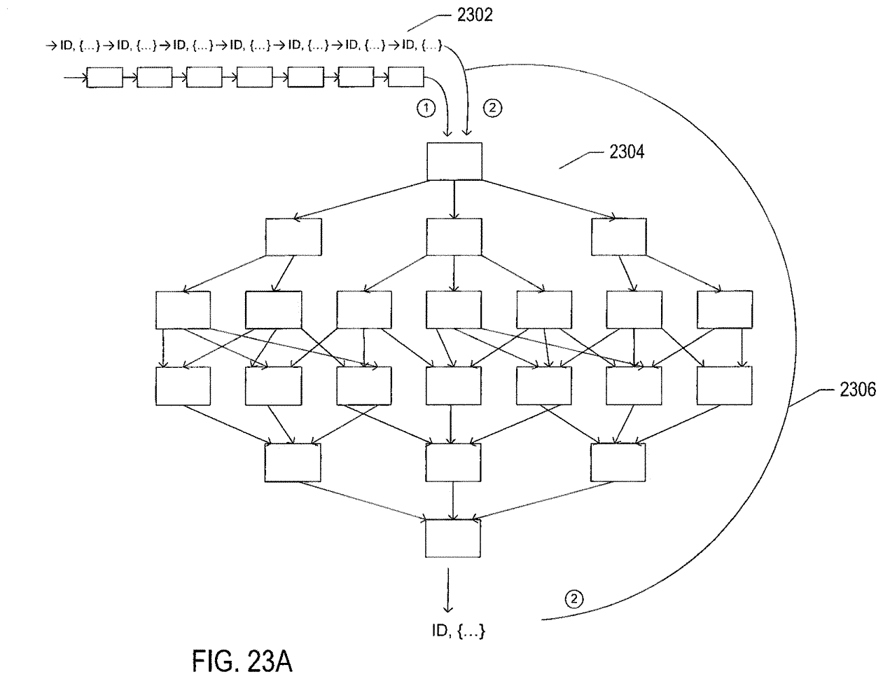

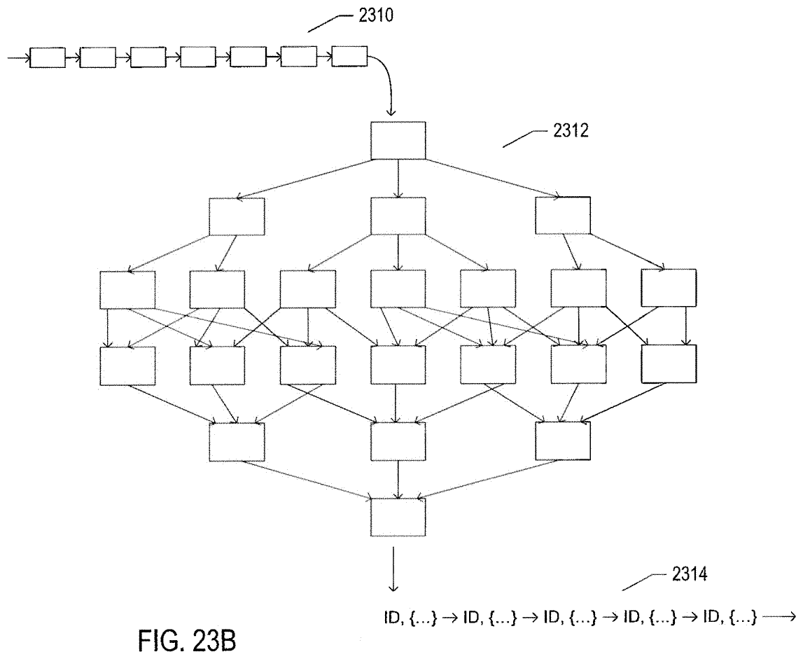

FIGS. 23A-B illustrate a machine-learning technique for generating an event_type( ) function and extraction and message-restoration functions ƒ( ) and ƒ¹( ). As shown in FIG. 23A, a training data set of log/event messages and corresponding compressed expressions 2302 is fed into a neural network 2304, which is modified by feedback from the output produced by the neural network 2306. The feedback-induced modifications include changing weights associated with neural-network nodes and can include the addition or removal of neural-network nodes and neural-network-node levels. As shown in FIG. 23B, once the neural network is trained, received log/event messages 2310 are fed into the trained neural network 2312 to produce corresponding compressed-message expressions 2314. As with the above-discuss clustering method, the neural network can be continuously improved through feedback-induced neural-network-node-weight adjustments as well as, in some cases, topological adjustments.

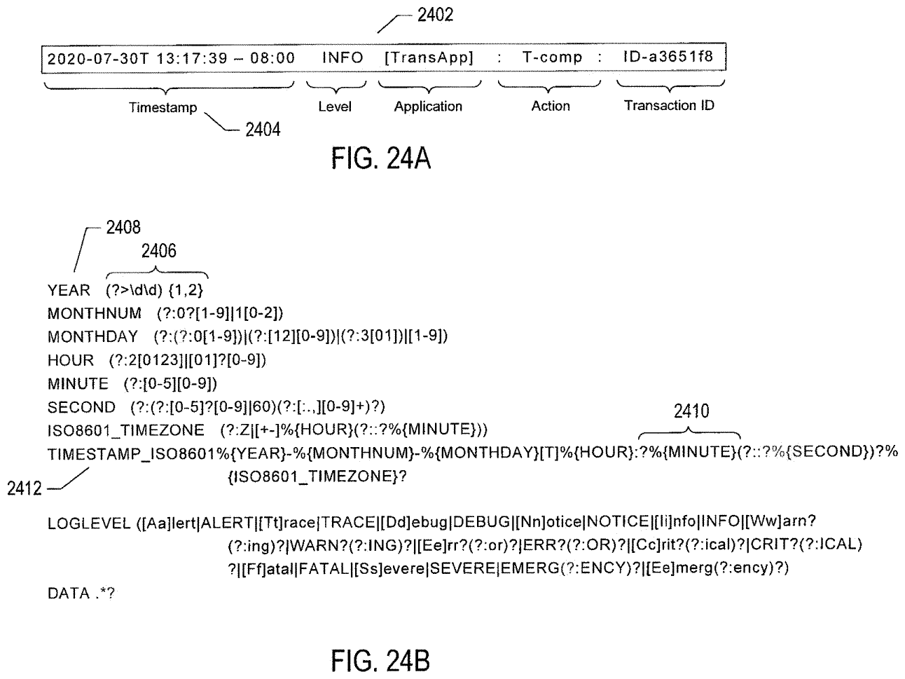

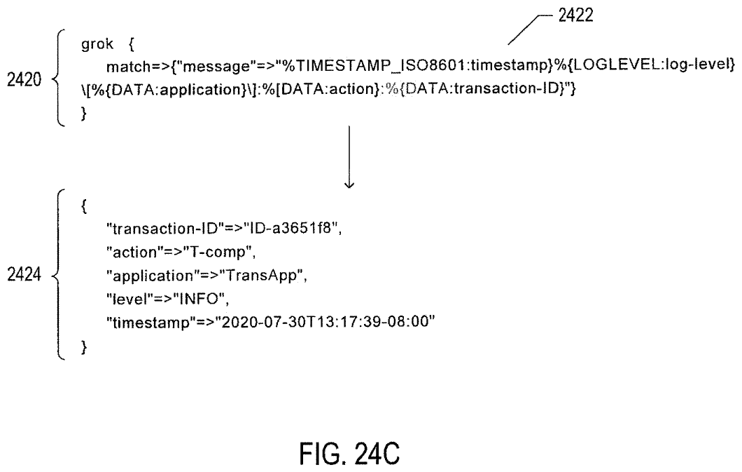

FIGS. 24A-C illustrate one approach to extracting fields from a log/event message. Log/event messages may be understood as containing discrete fields, but, in practice, they are generally alphanumeric character strings. An example log/event message 2402 is shown at the top of FIG. 24A. The five different fields within the log/event message are indicated by labels, such as the label “timestamp” 2404, shown below the log/event message. FIG. 24B includes a variety of labeled regular expressions that are used, as discussed below with reference to FIG. 24C, to extract the values of the discrete fields in log/event message 2402. For example, regular expression 2406 follows the label YEAR 2408. When this regular expression is applied to a character string, it matches either a four-digit indication of a year, such as “2020.” or a two-digit indication of the year, such as “20.” The string “\d\d” matches two consecutive digits. The “(?>” and “)” characters surrounding the string “\d\d” indicates an atomic group that prevents unwanted matches to pairs of digits within strings of digits of length greater than two. The string “{1, 2}” indicates that the regular expression matches either one or two occurrences of a pair of digits. A labeled regular expression can be included in a different regular expression using a preceding string “%{” and a following symbol “},” as used to include the labeled regular expression MINUTE (2410 in FIG. 24B) in the labeled regular expression TIMESTAMP_ISO8601 (2412 in FIG. 24B). There is extensive documentation available for the various elements of regular expressions.

Grok parsing uses regular expressions to extract fields from log/event messages. The popular Logstash software tool uses grok parsing to extract fields from log/event messages and encode the fields according to various different desired formats. For example, as shown in FIG. 24C, the call to the grok parser 2420 is used to apply the quoted regular-expression pattern 2422 to a log/event message with a format of the log/event message 2402 shown in FIG. 24A, producing a formatted indication of the contents of the fields 2424. Regular-expression patterns for the various different types of log/event messages can be developed to identify and extract fields from the log/event messages input to message collectors. When the grok parser unsuccessfully attempts to apply a regular-expression pattern to a log/event message, an error indication is returned. The Logstash tool also provides functionalities for transforming input log/event messages into event tuples. The regular-expression patterns, as mentioned above, can be specified by log/event-message-system users, such as administrative personnel, can be generated by user interfaces manipulated by log/event-message-system users, or may be automatically generated by machine-learning-based systems that automatically develop efficient compression methods based on analysis of log/event-message streams.

### Currently Disclosed Methods and Systems

FIG. 25 shows an example log/event message that includes confidential and sensitive information. In FIG. 25, bolded rectangles, such as rectangle 2502, are superimposed on the example log/event message 2504 to indicate portions of sensitive fields. As can be seen, this log/event message contains numerous so-called “secret” hash values which may be used for encryption purposes as well as other information potentially related to computational methods used to protect computer systems. It is quite common for developers, unaware of the implications of exposing confidential and sensitive information in log/event messages, to generate log/event messages that contain confidential and sensitive information. However, as next discussed, log/event messages are often rendered accessible by interested and potentially malicious entities, and the confidential and sensitive information that they contain may be used to compromise the security of the distributed computer system in which the log/event messages are generated, the security of one or more organizations that use the distributed computer system, and the security of users of computer systems.

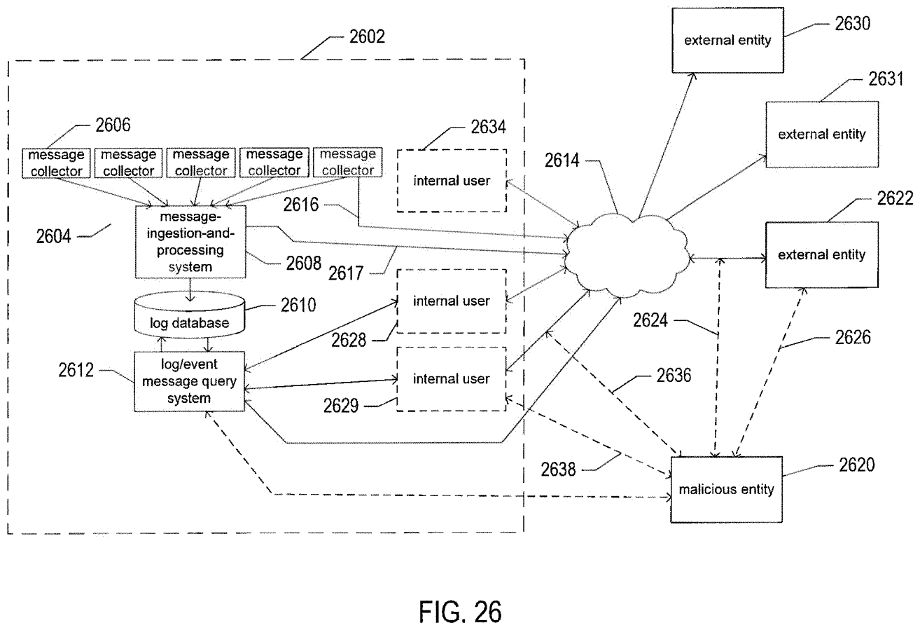

FIG. 26 illustrates various of the potential confidential-and-sensitive-information points of exposure related to a log/event-message system within a distributed computer system. The distributed computer system is represented by dashed rectangle 2602. A log/event-message subsystem 2604 within the distributed computer system is represented using the illustration conventions used in the above-discussed FIG. 14, and includes message collectors, such as message collector 2606, a message-ingestion-and-processing subsystem 2608, a log database 2610, and a log/event-message query subsystem 2612. As discussed hove with reference to FIGS. 16-18, message collectors and/or message-ingestion-and-processing subsystems may, in the course of processing log/event messages, forward log/event messages, portions of log/event messages, and/or alerts and notifications that contain information extracted from log/event messages to various computational entities. While these forwarding operations may commonly employ secure internal networks within the distributed computer system to send log/event messages, notifications, and alerts to servers and other processor-controlled subsystems within the distributed computer system, the forwarding operations may, in addition, result in log/event messages, notifications, and alerts being transmitted to target entities via external networks, including the Internet, 2614, as represented by arrows 2616-2617. These log/event messages, notifications, and alerts may therefore be exposed to access by a malicious entity 2620 in the course of transmission to an external entity 2622, as represented by arrow 2624, or following their reception and storage within an external entity, as represented by arrow 2626. Users running on servers within a distributed computer system, referred to as “internal users,” 2628-2629 may access log/event messages through the log/event-message query subsystem 2612 and then forward retrieved log/event messages to external entities 2630-2631 and 2622 or to another internal user 2634 via an external network 2614. The malicious entity 2620 can intercept such log/event messages during transmission, as represented by arrows 2636, or access log/event messages by unauthorized access of internal computer systems, as represented by arrow 2638. While responsible system administrators generally seek to control access to confidential and sensitive information by a variety of different methods and technologies, including encryption, access control lists, firewalls, password protection, and security technologies built into operating systems, virtualization layers, and distributed-computer operating systems and virtualization technologies, it is very difficult to deploy and monitor these methods and technologies to ensure that sensitive and confidential information inadvertently included in log/event messages is protected from access by malicious entities or inadvertent exposure.

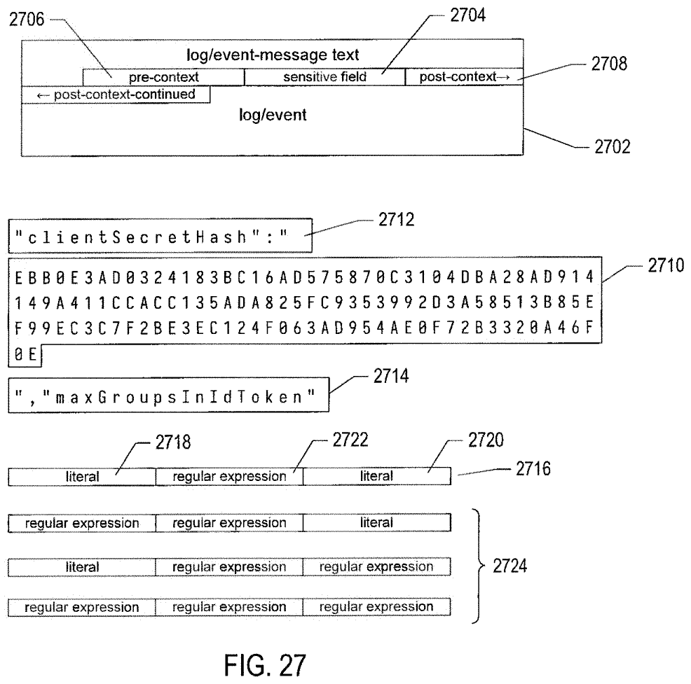

It is for the reasons discussed above that log/event-message processing commonly includes provisions for detecting and masking confidential and sensitive information included in log/event messages within the log/event-message subsystem, prior to log/event-message forwarding and storage as well as transmission of alerts and notifications based on log/event messages. FIG. 27 illustrates a basis for one approach to providing masking rules to implement masking of confidential sensitive information in log/event messages by rule-based log/event-message processing, discussed above with reference to FIGS. 16-18. An abstract representation 2702 of a log message is shown at the top of FIG. 27. As discussed above, a log/event-message is a block of text, generally including alphanumeric characters, punctuation characters, and white space. A sensitive field within the log/event message is represented by rectangle 2704. Examples of the contents of sensitive fields include: (1) login credentials, such as a username and/or password; (2) an address and access credentials for a server, appliance, or subsystem within a distributed computer system, which may include a uniform resource locator (“URL”), port number, and other such information; (3) a secret key and/or key hash, used to gain access to virtual machines, containers, and other computational entities; (4) an infrastructure-access key; (5) other types of access keys and credentials; (6) an address and/or identifier for an internal component of the distributed computer system; and (7) other confidential information, such as a credit-card number, phone number, social-security number, contact information, filename, and other personal information. Because log/event messages generally exhibit regular patterns, such as key/value pairs and fields, and because fields within log/event messages are generally ordered, with each different type of log/event message exhibiting a predictable field order, sensitive and confidential fields can often be identified based on the text content in which the occur. Therefore, a set of preceding characters, referred to as the “pre-context,” 2706 and a set of following characters, referred to as the “post-context,” 2708 can be used to characterize and identify a sensitive field 2704 bracketed by the pre-context and post-context characters. As an example, referring back to FIG. 25, the secret hash contained in bolded rectangle 2506, reproduced as block 2710 in FIG. 27, is preceded by the set of characters 2712 and is followed by the set of characters 2714. Presumably, other log/event-messages of the same type would also include a secret hash, different from the secret hash in block 2710, embedded between the same or similar pre-context 2712 and post-context 2714 portions. Even though the secret hashes may differ, it may be the case that all of the secret hashes have certain common characteristics. For example, the secret hash 2710 appears to include only alphanumeric characters, including both lower-case and upper-case letters. When such common characteristics can be discerned and expressed using a regular expression, an identifier for a particular confidential-and/or-sensitise field can be constructed using the pre-context, the regular expression for the confidential-and/or-sensitive field, and the post-context. The most common identifier 2716 users a literal string for the pre-context 2718 and post-context 2720 as well as the regular expression 2722 for the sensitive field, and this type of identifier is assumed in subsequent discussions. However, since a literal is also generally a regular expression, and since the pre-context and post-context may somewhat vary from one log/event-message to another, it is also possible to construct an identifier using regular expressions for either or both of the pre-context and post-context 2724.

A pre-context/regular-expression/post-context triple serves as an identifier, or locator, for a particular type of sensitive field within a log/event message, and can be used in the criteria portion of a log/event-message processing rule, as discussed above with reference to FIG. 19. Grok parsing, discussed above with reference to FIG. 24C, can be used, along with a pre-context/regular-expression/post-context triple, to identify sensitive fields in log/event messages in order to determine whether a particular masking rule applies to the log/event messages as well as to direct a masking operation associated with the particular masking rule to mask the contents of the sensitive fields.

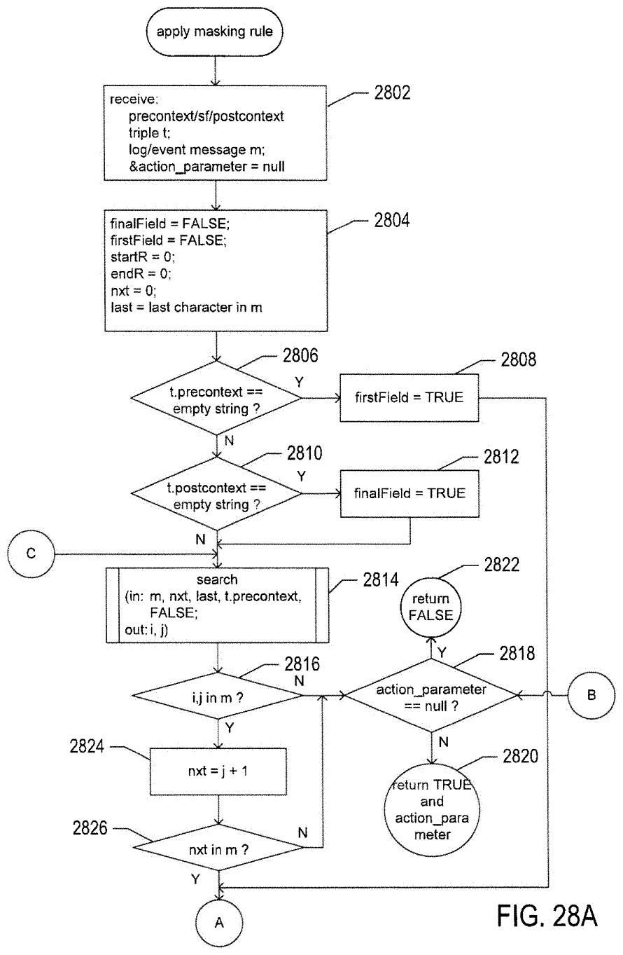

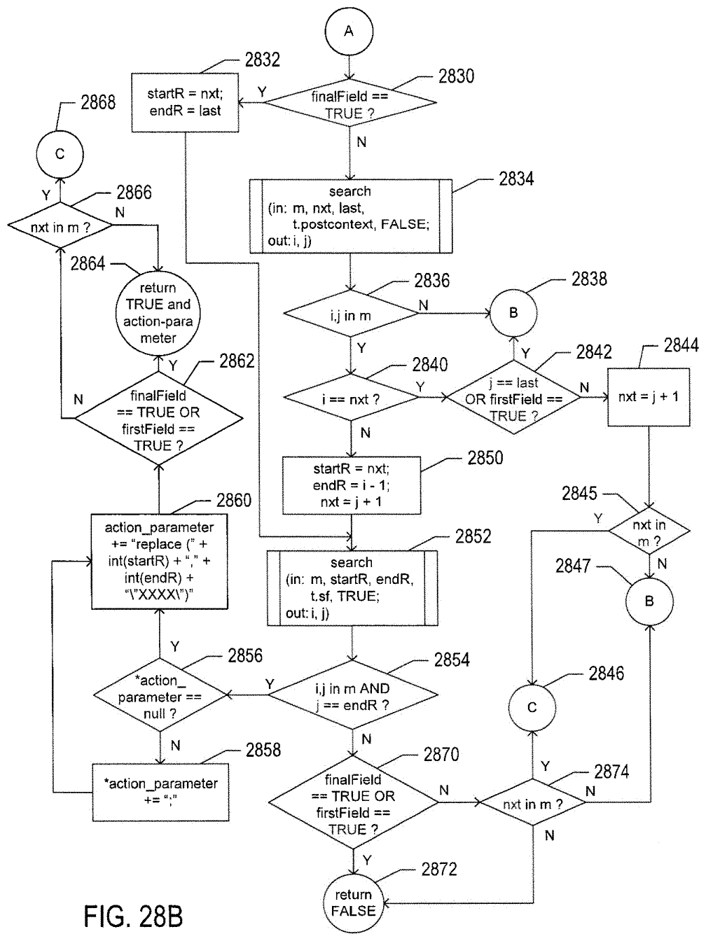

FIGS. 28A-B provide control-flow diagrams for a routine “apply masking rule” which applies a masking rule to a log/event message to identify and locate a sensitive field specified by a pre-context/regular-expression/post-context triple in the criteria portion of the masking rule. In step 2802, the routine “apply masking rule” receives a pre-context/regular-expression/post-context triple t, a log/event message m, and a reference to a memory location that stores an action/parameter portion of a rule, which is set to null. An action/portion is returned, when the rule is successfully applied, to be stored, as in step 1741 in FIG. 17B, discussed above, for subsequent use when the message-processing task represented by the rule is carried out, as in the for-loop of steps 1752-1760 in FIG. 17C. In step 2804, the routine “apply, masking rule” sets a local variable finalField to FALSE, a local variable firstField to FALSE, local variables startR, endR, and nxt to 0, and local variable last to the index of, or a pointer to, the last character in message m. When the pre-context portion of triple t contains the empty string, as determined in step 2806, the local variable firstField is set to TRUE, in step 2808, and control flows to the first step in FIG. 28B. In this example implementation, the pre-context can be null only in the case that the sensitive field is required to be the first field in the log/event message m. When the post-context portion of triple t contains the empty string, as determined in step 2810, the local variable finalField is set to TRUE, in step 2812. In this example implementation, the post-context can be null only in the case that the sensitive field is required to be the final field in the log/event message m. Of course, alternative implementations may provide for null contexts in other cases. In step 2814, the routine “apply masking rule” uses grok parsing or another type of text searching to search for the pre-context portion of triple t in the portion of message m beginning at the position indicated by local variable nxt and ending at the position indicated by local variable last, by calling a routine “search,” which returns the character positions i and j of the first and last pre-context characters in the sensitive field when the pre-context text is found in message m and otherwise returning values that do not correspond to character positions in message m. The routine “search” receives input arguments m, nxt, last, t.preconext, and a Boolean value indicating whether or not the character string to be searched for is represented by a literal, as in the current case in which t.preconext is assumed to be a literal, or by a regular expression. When the returned character positions i and j are not valid indices for, or pointers to, characters in message m, as determined in step 2816, the routine “search” failed to find the pre-context text in the indicated portion of message m, and control flows to step 2818, where the routine “apply masking rule” determines whether or not any action/parameter information has been previously stored in the memory address action_parameter. If so, then the routine “apply masking rule” returns, in step 2020, the value TRUE and, of course, the information stored in the memory location action_parameter. Otherwise, the routine “apply masking rule” returns FALSE, in step 2822. When the returned character positions i and j are valid indices for, or pointers to, characters in message m, as determined in step 2816, local variable nxt is set, in step 2824, to point to, or to store the index value of, the character in message m following the last character in the pre-context text found by the routine “search” in step 2814. When this results in the local variable nxt pointing to, or having an index value of, a character in message m, as determined in step 2826, control flows to the first step in FIG. 28B. Otherwise, triple t cannot be successfully applied to message m, since there are no additional characters to which to map the regular-expression and post-context portions of triple t, and, therefore, control flows to step 2818, described above.

Turning to FIG. 28B, the routine “apply masking rule” next determines whether the local variable finalField is TRUE, in step 2830. If so, there is no post-context, and therefore local variable startR is set to the value of local variable nxt, in step 2832, and control flows to step 2852, where the routine “apply masking rule” searches for the sensitive field. Otherwise, in step 2834, the routine “search” is again called to search for the post-context in message m. When the returned character positions i and j fail to indicate positions within message m, as determined in step 2836, the search failed, and therefore control flows, as indicated by step 2838, back to step 2818 in FIG. 28A, for termination of the routine “apply masking rule.” Similarly, when the first position of the found post-context text in message m is equal to the starting character of the portion of message m that was searched, as determined in step 2836, no sensitive field can occur between the pre-context and post-context. In this case, when the identified post-context text occurs at the end of message m or the sensitive field needs to be the first field in message m, as indicated by local variable firstField having the value TRUE, as determined in step 2042, control flows to step 2838 for termination of the routine “apply masking rule.” Otherwise, in step 2844, local variable nxt is set to indicate the character following the identified post-context in message m. When nxt indicates the position of a character in message m, as determined in step 2845, control flows through step 2846 back to step 2814 in FIG. 28A, where the routine “apply masking rule” attempts again to identify the location of the significant field represented by triple t in the remaining portion of message m. Otherwise, control flows through step 2847 to step 2818 in FIG. 28A, from which the routine “apply masking rule” terminates. When the first position of the found and post-context text in message m is not equal to the starting character of the portion of message m that was searched, as determined in step 2836, local variable startR is set to the value stored in local variable nxt, local variable endR is set to the character preceding the location of the post-context text found in the search carried out in step 2834, and local variable nxt is set to the first character following the location of the post-context text, in step 2850. In step 2852, the routine “apply masking rule” carries out a search of the characters in between the identified pre-context and post-context, from the start of message m to the start of the post-context, when the significant field must be the first field in the message, or from the character following the identified pre-context to the end of message m when the significant field must be the final field in the message. When this portion of the message satisfies the regular expression t.sf in triple t, as determined in step 2854, the routine “apply masking rule” determines whether or not any action/parameter information has already been stored in the memory location action_parameter, in step 2056. If so, then a semicolon is appended to that information, in step 2858. In step 2816, a replacement action in the form of a function call to a function “replace” is appended to the contents of the memory location action_parameter. When the sensitive field must be the first or final field in message m, as determined in step 2862, the routine “apply masking rule” returns the value TRUE in step 2864. Otherwise, in step 2866, the routine “apply masking rule” determines whether the local variable nxt indicates a character position within message m. If so, control flows through step 2868 back to step 2814 in FIG. 28A. Otherwise, control flows to step 2864, where the routine “apply masking rule” returns the value TRUE. When the search carried out in step 2852 indicates that the considered portion of the message 171 fails to satisfy the regular expression t.sf in triple t, as determined in step 2854, then when the significant field must be the first or final field in message m, as determined in step 2870, the routine “apply masking rule” returns the value FALSE, in step 2872. Otherwise, when the local variable nxt indicates the position of a character in message m, as determined in step 2874, control flows through step 2046 back to step 2814 in FIG. 28A. Otherwise, control flows through step 2047 to step 2818 in FIG. 28 A, from where the routine “apply masking rule” terminates.

Rule-based masking can be applied within message collectors and/or message-ingestion-and-processing subsystems of a log/event-message system to mask sensitive fields in log/event messages by replacing the content of sensitive fields with white space or specified replacement strings to prevent confidential and other sensitive information from being accessed by malicious entities or inadvertently made accessible from within insecure networks, data-storage appliances, and computer systems. However, as has been repeatedly realized when rule-based systems are implemented in practical situations, it is difficult and, in some cases, practically impossible to construct and maintain large sets of rules needed for specifying and/or controlling complex tasks. For example, it may often be the case that a particular type of sensitive field may be bracketed by pre-contexts and post-contexts with contents that vary from one log/event message to another. When literal pre-contexts and post-contexts are used to locate sensitive fields in log/event messages, a large number of specific rules may be necessary to handle the many different variable pre-contexts and post-contexts. If, instead, regular expressions are used for identifying pre-contexts and post-contexts, great care may need to be taken in order to develop regular expressions with sufficient specificity to locate sensitive fields accurately. In many cases, it may not be possible to identify sensitive fields using regular-expression-based pre-contexts and post-contexts without inadvertently also identifying non-sensitive fields as being sensitive. Because regular expressions can be very difficult to construct, the likelihood of regular-expression-based pre-contexts and post-contexts resulting in failures to accurately identify sensitive fields is quite high. This is also true for the regular expressions used to locate sensitive fields between identified pre-contexts and post-contexts. For reliable masking, those assigned to develop masking rules need also be aware of all the different possible sensitive fields and sensitive-field contexts and need to reliably track inevitable changes to log/event-message formats, over time, in order to maintain an updated set of masking rules. These are very challenging undertakings that are prone to human error. Even when carried out with painstaking care, it is often the case that some number of previously undetected sensitive fields fail to be identified and masked by rule-based masking prior to detection of the sensitive fields and subsequent development of new masking rules to handle them. For all of these reasons, rule-based masking is associated with a sufficient number of serious deficiencies that rule-based masking tends not to be used at the usage levels needed to provide for secure collection, storage, and querying of log/event messages by log/event-message subsystems. The currently disclosed methods and systems have been developed to address these serious deficiencies.

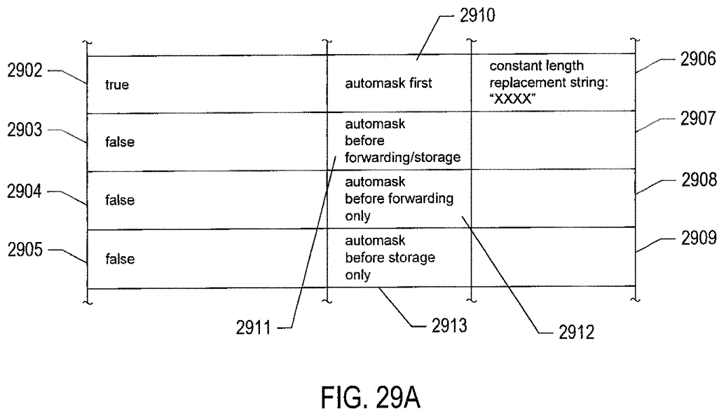

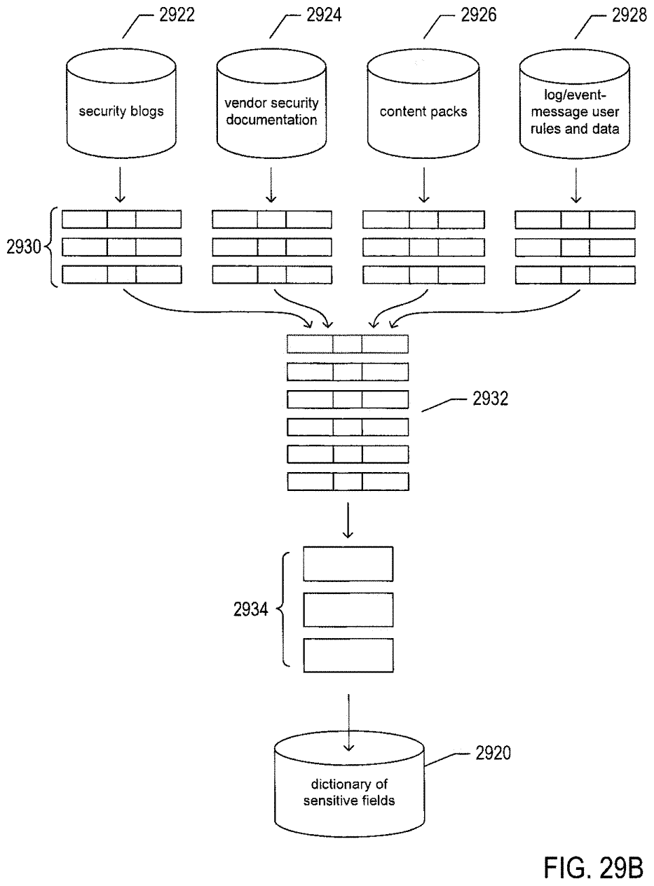

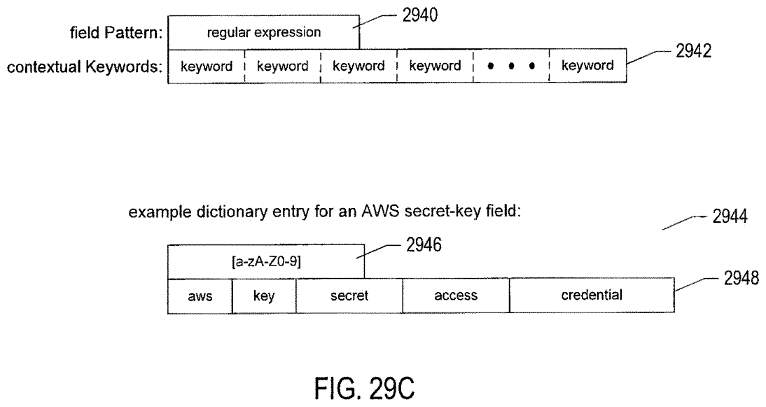

The currently disclosed methods and systems are directed to automated sensitive-field masking by log/event-message subsystems. Not only is sensitive-field masking automatically applied, as log/event messages are received and collected by the log/event-message subsystems, the information needed to carry out sensitive-field masking is also automatically generated. FIGS. 29A-C show basic components and features of the currently disclosed automated sensitive-field masking methods employed within log/event-message subsystems. In the currently described implementation, specific masking rules, described above, are replaced by more general automated-masking rules that serve to activate or deactivate various different automated-masking variants. In FIG. 29A, examples of such general automated-masking rules are shown in a portion of the rules table described above with reference to FIG. 19. The criteria portions 2902-2905 of the four example automated-masking rules 2906-2909 each contains only a single Boolean value. When the Boolean value is TRUE, the type of masking specified by the rule is carried out on all received log/event messages, unless exceptions are specified, as discussed below. When the Boolean value is FALSE, the type of masking specified by the rule is not carried out for any received log/event message. In the currently described implementation, the various masking-rule variants are mutually exclusive, so that only a single automated-masking rule has a criteria portion with the Boolean value TRUE at any given time. The action portions of the rules 2910-2913 specify the type of masking to be carried out when the rule is active. Automated sensitive-field masking is carried out prior to any other message processing, as indicated by the action “automask first,” when the first rule 2902 is active. Other of the rules specify that sensitive-field masking should occur prior to forwarding any log/event messages, prior to storing any log/event messages, or prior to either forwarding or storing log/event messages. Additional masking-rule variants, of course, may be implemented, including variants the specify in which components of a log/event-message subsystem automated masking is carried out. The parameters portion of the rules may specify masking details, such as replacement of sensitive fields with fixed-length replacement strings, replacement of sensitive fields with variable-length replacement strings, encoding sensitive fields so that their original values can be subsequently recovered, and other types of masking operations. The parameters that specify a particular automated-masking variants can be alternatively specified through a user interface. In alternative implementations, automated masking is also invoked through a user interface, rather than by activation of automated-masking rules. However, rules are used in the described implementation in order to incorporate automated masking into the above-described rule-based log/event-message processing.

FIG. 29B illustrates one component that is common to numerous different implementations of the currently disclosed methods and systems. Training data is furnished to currently disclosed automated-masking subsystems within log/event-message subsystems in order that the automated-masking subsystems are each able to generate a sensitive-field dictionary 2920. The training data is generated from one or more of various data sources, including descriptions of sensitive fields in security blogs 2922, various types of vendor security documentation 2924, content packs provided by vendors of log/event-message subsystems 2926, and traditional log/event-message rules created by users of traditional log/event-message subsystems that employee rule-based masking 2928. In all cases, pre-context/sensitive-field/post-contexts triples, such as triples 2930, are prepared from, or indicated within, the source data and annotated with indications of the type of sensitive field and the type of data source from which they are extracted. In alternative implementations, when event types are available for the log/event messages obtained from data sources, the event types can also be included in the training data and used to generated numeric sensitive-field identifiers particular to event types. The pre-context/sensitive-field/post-contexts triples can be thought of as being collected together into a stream of pre-context/sensitive-field/post-context triples 2932. The stream of pre-context/sensitive-field/post-context triples is automatically converted into a stream of dictionary entries 2934 which are stored in the dictionary of sensitive fields 2920.

FIG. 29C illustrates the format for dictionary entries used in the described implementation. Each dictionary entry includes a regular expression 2940 and a list 2942 of contextual keywords. The regular expression 2940 represents the possible types of content that can occur in the sensitive field. For example, a regular expression may indicate that a sensitive field must contain only alphanumeric characters and have a length of between 8 and 16 characters. More complex and more specific regular expressions made be developed for various different types of sensitive fields, as further discussed below. The contextual keywords are canonical terms that are likely to occur within a text window that includes the sensitive field. This differs from the above-described pre-contexts and post-contexts of traditional masking rules. In traditional masking rules, the pre-contexts and post-contexts are generally specified by literals and are thus very specific. Moreover, a particular rule is applicable only when the exact literals corresponding to the pre-context and post-context for a particular sensitive field bracket a text string compatible with the regular expression for the sensitive field. Contextual keywords are more probabilistically evaluated, as discussed below, and can occur in either or both of the pre-context and post-context of sensitive field.

An example dictionary entry 2944 is provided in FIG. 29C. The regular expression 2946 indicates that the sensitive field represented by the dictionary entry can include any number of lower-case and upper-case characters and numeric base-10 digits. The list of contextual keywords 2948 indicates that the terms “aws,” “key,” “secret,” “access,” and “credential” are likely to occur within a context window that includes the sensitive field represented by the entry 2944.

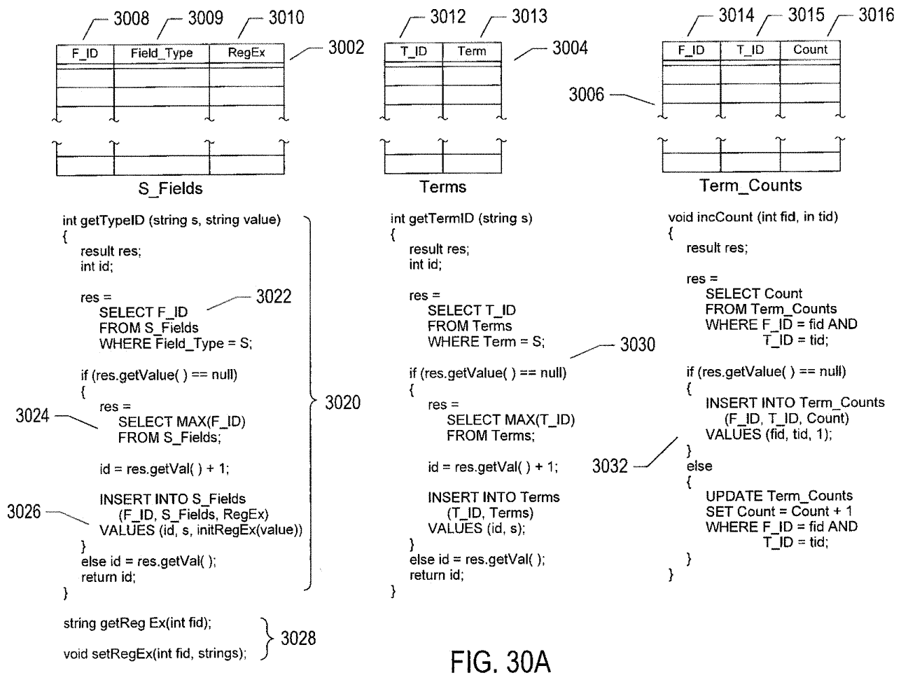

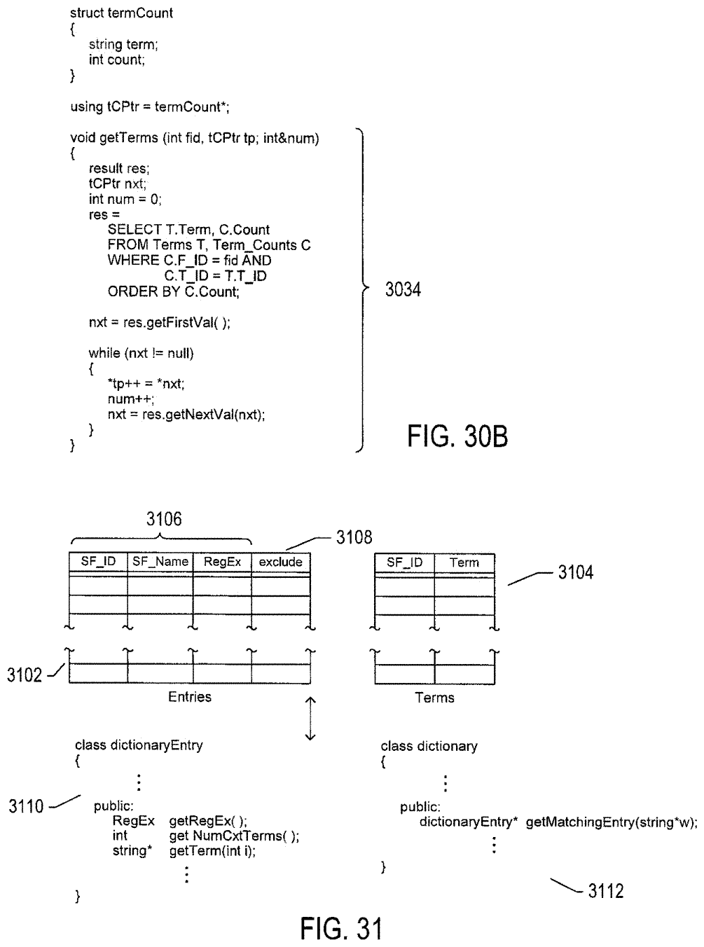

FIGS. 30A-B and 31 illustrate one approach to implementing a sensitive-field dictionary using relational-database tables. Many alternative implementations are possible, including implementations that use a variety of non-relational databases that support efficient text searching. During dictionary construction, the three relational-database tables S_Fields 3002, Terms 3004, and Term_Counts 3006 are used to store data accumulated during processing of the stream of pre-context sensitive-field/post-contexts triples obtained from the various training-data sources. Following processing of the stream of pre-context/sensitive-field/post-contexts triples, dictionary entries are generated from the accumulated data and stored in the relational-database tables Entries 3102 and Terms 3104 shown in FIG. 31. Table S_Fields 3002 includes three fields, or columns: (1) F_ID 3008, which contains numerical identifiers for sensitive fields; (2) Field_Type 3009, which contains an alphanumeric-character string representing the sensitive-field type; and (3) RegEx 3010, which stores a regular expression specifying the allowable contents for the sensitive field. Table Terms 3004 includes two columns: (1) T_ID 3012, containing numerical identifiers for terms extracted from sensitive-field contexts; and (2) Term 3013, containing alphanumeric-character-string representations of extracted terms. Table Term_Counts 3006 includes three fields, or columns: (1) F_ID 3014, containing foreign-key numerical identifiers for sensitive fields; (2) T_ID 3015, containing foreign-key numerical identifiers for extracted terms; and (3) Count 3016, storing integer counts of the occurrences of the extracted terms. FIG. 30A additionally includes pseudocode representations of various routines used during dictionary creation as examples of how the relational-database tables are used to implement dictionary creation. The routine getTypeID 3020, for example, returns the numerical identifier for a sensitive field specified by the character-string argument s. When an entry for the sensitive field is already present in the table S_Fields, the numerical identifier is obtained by the simple structured-query-language “SQL”) query 3022. The local variable res acts like an embedded-SQL cursor. When an entry for the sensitive field has not yet been entered into table S_Fields, a new entry for the sensitive field is generated and inserted into table S_Fields by the two SQL queries 3024 and 3026. Declarations for simple routines for entering and retrieving field values 3028 are shown below the pseudocode implementation of the routine getTypeID 3020. Similar implementations are also shown in FIG. 30A for a routine getTermID( ) 3030 that obtains the numerical identifier for a term 3030 or creates a new entry for the term, when no entry is already present in table Terms, and for a routine incCount 3032 that updates a term count or creates, when necessary, a new term-count entry. FIG. 30B shows a pseudo-code implementation of a routine getTerms 3034 which extracts all of the context terms, and associated counts, identified for a particular sensitive field from the dictionary-creation database comprising tables S_Fields, Terms, and Term_counts. FIG. 31 shows portions of class declarations 3110 and 3112 for code that, in combination with relational-database tables Entries 3102 and Terms 3104, implements dictionary entries and a sensitive-field dictionary. The pseudocode implementations and class declarations are examples of how the relational-database implementation of a storage system for data harvested from the stream of pre-context/sensitive-field/post-contexts triples is employed during dictionary creation. The currently discussed implementations of log/event-message-masking subsystems thus implemented by a combination of a relational database and computer-instruction-implemented routines.

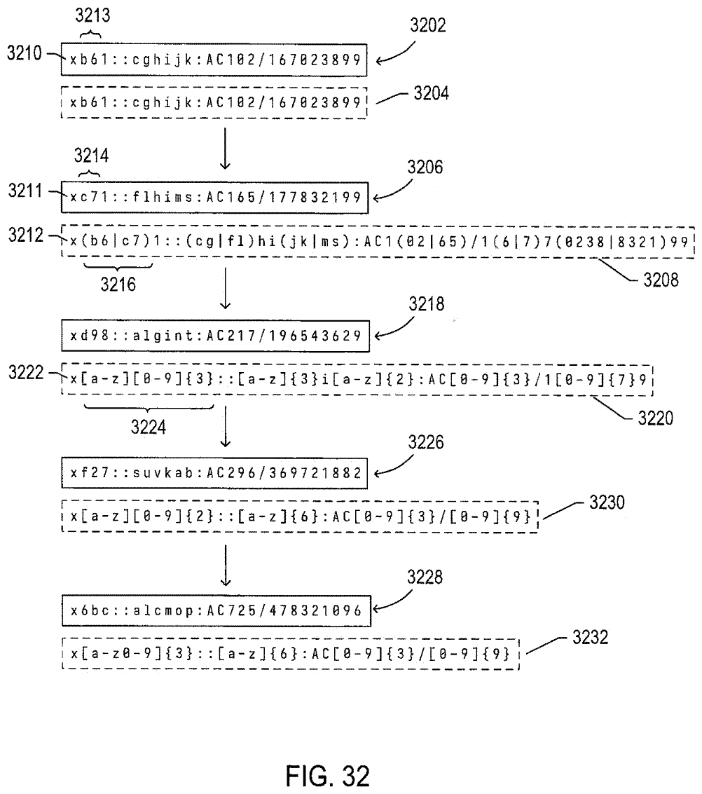

FIG. 32 illustrates progressive determination of a regular expression for the contents of a sensitive log/event-message field. The regular expression for each sensitive field is generated during processing of the stream of pre-context/sensitive-field/post-contexts triples, obtained from various training-data sources, that is supplied as training data to a log/event-message-masking subsystem. FIG. 32 shows a stepwise generation of a regular expression for a sensitive field. In a first step, the contents of a first occurrence of the sensitive field detected in the training data 3202 is received and a corresponding regular expression 3204 is generated from the received contents by simply copying the literal contents of the sensitive field into the regular expression. In other words, a literal character string can be viewed as a very specific regular expression that represents exactly the literal character string. In a next step, the contents of a second occurrence of the sensitive field in the training data is received 3206. These contents are compared with the current regular expression for the sensitive field 3204 to generate an updated or refined regular expression 3208 representative of both the contents of the first occurrence of the sensitive field 3202 as well as the contents of the second occurrence of the sensitive field 3206. The contents of both occurrences begin with the character “x” 3210-3211, so the refined regular expression 3208 specifies that the sensitive field must begin with the character “x” 3212. The contents of the first occurrence of the sensitive field next includes the character pair “b6” 3213 while the contents of the second occurrence of the sensitive field includes the character pair “c7” 3214, so the refined regular expression specifies that the next two characters in the sensitive field must be either “b6” or “c7” 3216. Thus, the refined regular expression is a combination of literal characters and short pairs of alternative characters or character strings. In a third step, the contents of the third occurrence of the sensitive field 3218 are received and compared to the current regular expression 3208 to generate a further refined regular expression 3220 that encompasses all three received occurrences of the sensitive field. Because all three occurrences begin with the character “x,” the further refined regular expression indicates that the first character of the sensitive field must be “x” 3222. Now, however, the refined expression indicates that the next three characters can be any combination of lower-case letters and digits 3224, since the second through fourth characters in the contents of the third occurrence of the sensitive field are quite different from those included in the contents of the first and second occurrences of the sensitive field. As more and more examples of the contents of the sensitive field are received 3226 and 3228, the resulting subsequently refined regular expression 3230 and 3232 generally become more general, simpler, and shorter. The goal is that the final regular expression for the sensitive field should encompass all observed occurrences of the sensitive field in the training data but should be a regular expression that is only general or broad enough to economically encompass those occurrences without producing a regular expression that encompasses many additional types of contents that are not observed in the training data. The final regular expression should be sufficiently specific to serve as a filter during processing of subsequently received log/event messages by the log/event-message subsystem, as further discussed below.

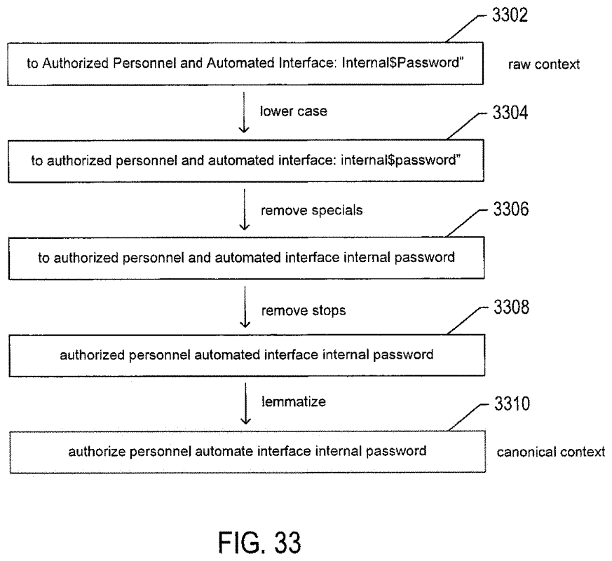

FIG. 33 illustrates various text-processing operations used in the currently disclosed log/event-message masking subsystems to generate a canonical context from a raw context associated with a sensitive field in a log/event message. The example raw context 3302 represents the pre-context portion of a sensitive field. In a first step, upper-case letters are changed to corresponding lower-case letters to produce a case-adjusted context 3504. In alternative implementations, lower-case letters could instead be changes to corresponding upper-case letters. In a next step, non-alphanumeric, or special, characters are removed to produce an alphanumeric context 3506. In a third step, various types of short words, referred to as “stop words,” are removed to produce a processed context 3508. The short words include articles and many prepositions. In a final step, referred to as “lemmatization.” various variant forms of root words are replaced by the root words to produce a canonical context 3510. Reducing raw contexts to canonical contexts results in production of the essential contents common to multiple variants of the context of a sensitive field that occur in multiple log/event messages. This facilitates accurate identification of the sensitive field within log/event messages.

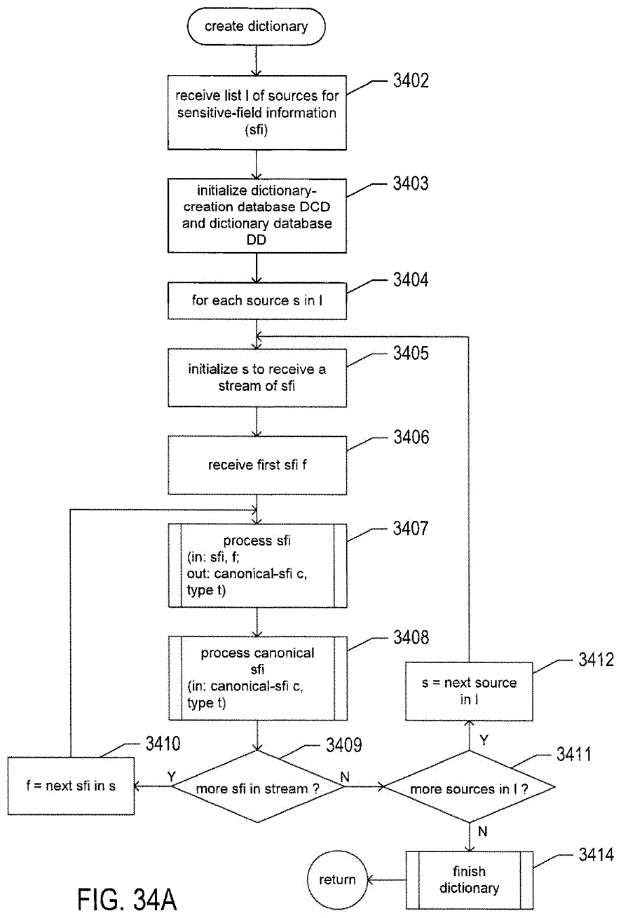

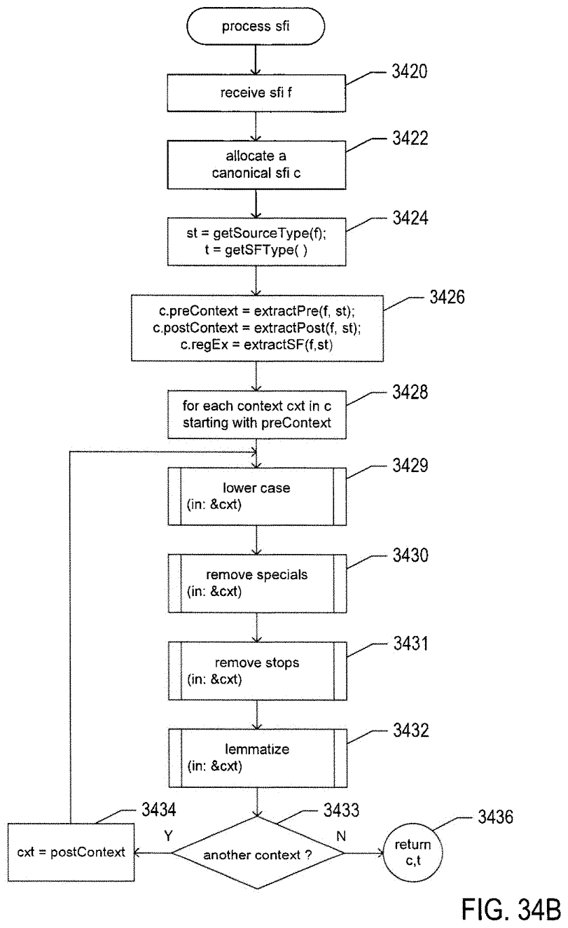

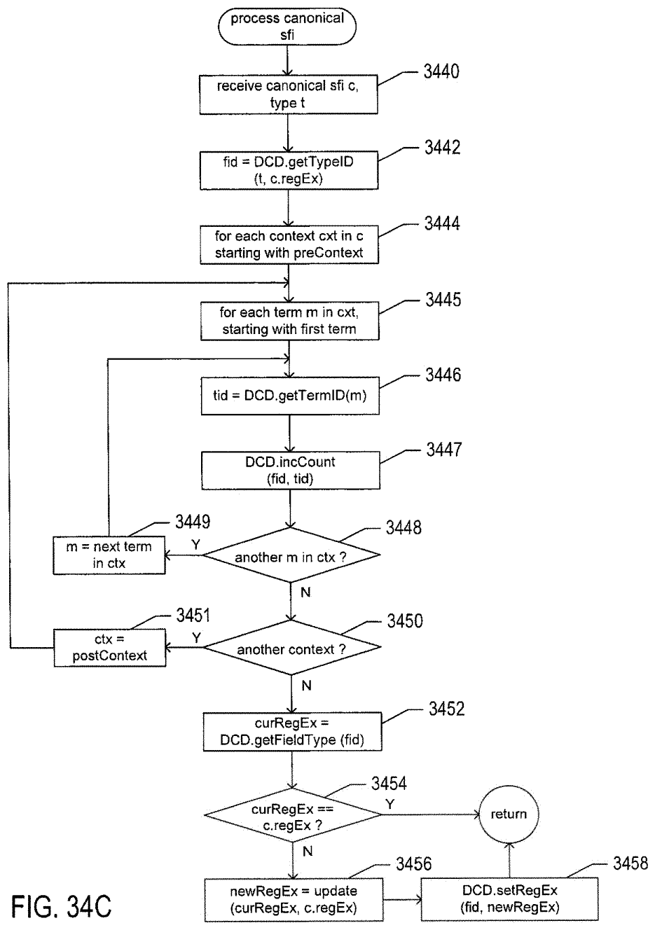

FIGS. 34A-C provide control-flow diagrams that illustrate one implementation of a dictionary-creation routine used by a masking subsystem of a log/event-message subsystem. FIG. 34A provides a flow-control diagram for a routine “create dictionary.” In step 3402, the routine “create dictionary” receives a list l of sources for sensitive-field information. As discussed above, sensitive-field information generally consists of pre-context/sensitive-field post-context triples and indications of the sensitive-field type and data-source type for each triple. The sensitive-feel information may be manually, semi-automatically, or automatically generated from information extracted from the information sources, but, ultimately, human input is required, at some level, to identify sensitive fields in the log/event messages used to generate the training data set.

In step 3403, the routine “create dictionary” initializes the dictionary-creation database DCD, an example of which is discussed above with reference to FIGS. 30A-B, as well as the dictionary database DD, an example of which is discussed above with reference to FIG. 31. In the for-loop of steps 3402-3412, sensitive-field information is extracted from each training-data source s in the list of sources l and processed. In step 3405, the currently considered information source s is initialized to generate a stream of sensitive-field information. In step 3406, the routine “create dictionary” receives the first pre-context/sensitive-field/post-context triple from the currently considered information source s. In step 3407, the pre-context/sensitive-field/post-context triple is processed, via a call to a routine “process sfi,” to generate a corresponding triple with canonical contexts. Then, in step 3408, a routine “process canonical sfi” is called to process the triple with canonical contexts generated in step 3407. When there are more pre-context/sensitive-field/post-context triples available from the currently considered information source s, as determined in step 3409, a next pre-context/sensitive-field/post-context triple is received from the stream, in step 3410, and control returns to step 3407, where the next pre-context/sensitive-field/post-context triple is processed. Otherwise, when the currently considered information source s is exhausted, as determined in step 3409, and when there or more information sources in the list l, as determined in step 3411, a next information source is retrieved from the list as the currently considered information source s, in step 3412, and control flows back to step 3405 for processing the pre-context/sensitive-field/post-context triple produced by the new current information source s. Otherwise, in step 3414, a routine “finish dictionary” is called to generate the sensitive-field dictionary that is stored in the dictionary database DD. In this step, the sensitive fields accumulated during training-data processing along with the most frequently occurring canonical-context terms for each sensitive field are collected from the dictionary-creation database DCD and entered into the sensitive-field dictionary database DD. Various techniques can be used to choose the most frequently occurring, and therefore most relevant, terms. A frequency-of-occurrence threshold can be applied to each term associated with the sensitive field, for example. As another example, an ordered set of ratios of the number of log/event messages in which each of the canonical context terms occurs to the total number of log/event messages processed to generate the training data may be plotted to generate a discrete function. A cutoff value based on an inflection point in, or threshold applied to, the discrete function represented by the plot can then be chosen to determine which canonical context terms should be included in the dictionary entry for the term. Additional techniques may be applied to select the relevant canonical context terms for each type of sensitive field, including principle component analysis (“PCA”).

FIG. 34B provides a flow-control diagram for the routine “process sfi,” called in step 3407 of FIG. 34A. In step 3420, the routine “process sfi” receives a next sensitive-field-information item ƒ, which, as discussed above, may be a pre-context/sensitive-field/post-context triple along with a sensitive-field-type indicator and an indicator of the type of training-data source from which the sensitive-field item was obtained, but may also be alternatively formatted, depending on the source of the sensitive-field-information item. In step 3422, the routine “process sfi” allocates a canonical sfi storage location c. In step 3424, a local variable st is set to the information-source type and local variable t is set to the sensitive-field type. In step 3426, the pre-context, post-context, and contents of the sensitive field are extracted from the sensitive-field information item. The contents of the sensitive field are stored in the field regEx of the canonical sfi c. Then, in the for-loop of steps 3428-3434, both the pre-context and post-context portions of the data stored in c are processed by text-processing operations discussed above with reference to FIG. 33. This produces a canonical sfi that is returned, along with the sensitive-field type, in step 3436.

FIG. 34C provides a flow-control diagram for the routine “process canonical sfi,” called in step 3408 of FIG. 34A. In step 3440, the routine “process canonical sfi” receives the canonical sfi c and the sensitive-field type t output by the above-described routine “process sfi.” In step 3442, the above-described routine getTypeID( ) is called to obtain the numerical identifier fid for the sensitive-field type or, when information related to the sensitive-field type has not yet been processed, to generate a numerical identifier fid and create an entry in the table S_Fields for the sensitive-field type. Then, in the for-loop of steps 3444-3451, each of the pre-context and post-context fields in the canonical sfi c are processed. In the inner, nested for-loop of steps 3445-3449, each term m in the currently considered canonical context is considered. In step 3446, a numerical term identifier tid is obtained for the term via a call to the function getTermID( ), a pseudocode implementation 3030 for which is shown in FIG. 30A. Then, in step 3447, the routine incCount( ), and implementation for which 3032 is also shown in FIG. 30A, is called to update the count for the term. Following completion of the nested for-loops of steps 3444-3451, the current regular expression for the sensitive field is retrieved, in step 3452, from the dictionary-creation database DCD and stored in local variable curRegEx. If the contents of the regEx field of the received canonical sfi happens to be equal to the current regular expression for the sensitive field, as determined in step 3454, the routine “process canonical sfi” returns, since no refinement of the regular expression for the sensitive field is needed. Otherwise, in step 3456, the regular expression for the sensitive field is refined, or updated, as discussed above with reference to FIG. 32, and the refined regular expression is then stored in the dictionary-creation database in step 3458 before the routine “process canonical sfi” returns.

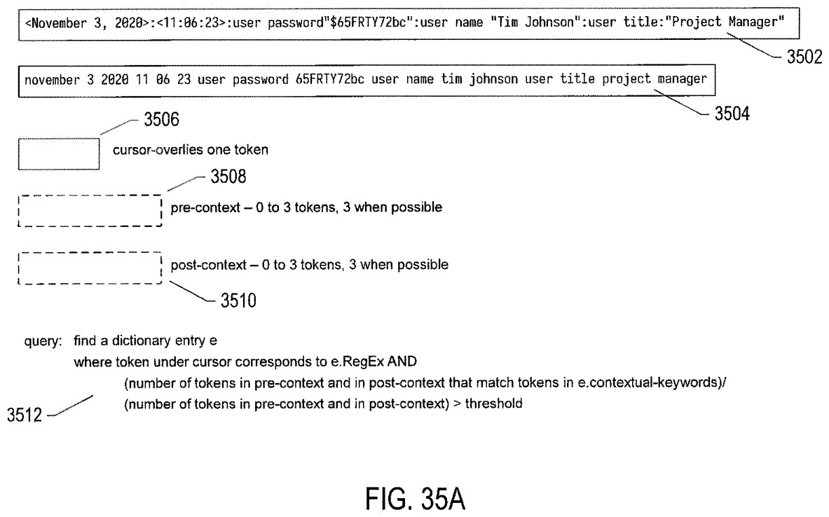

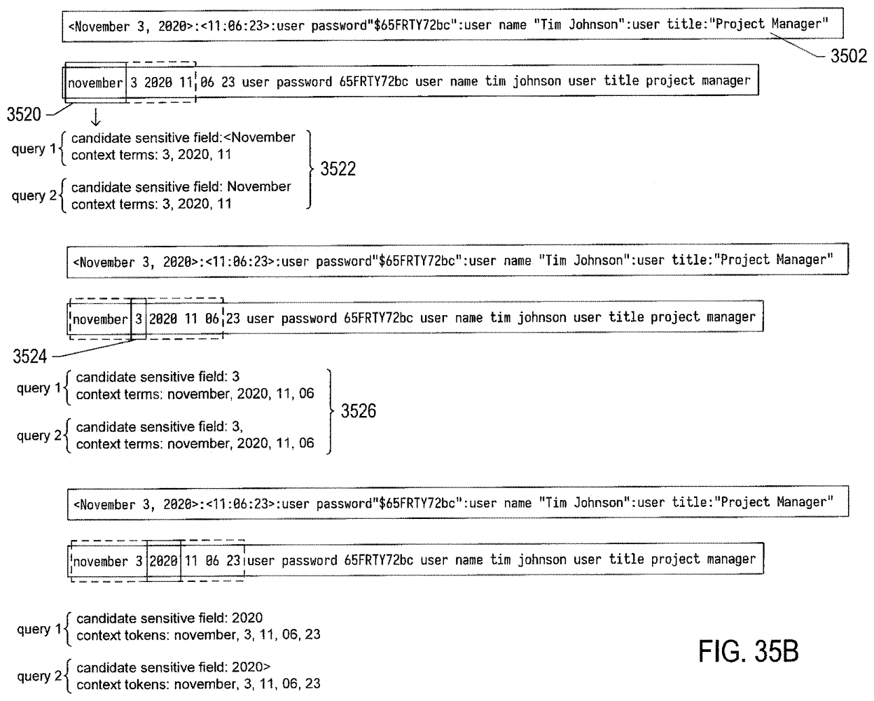

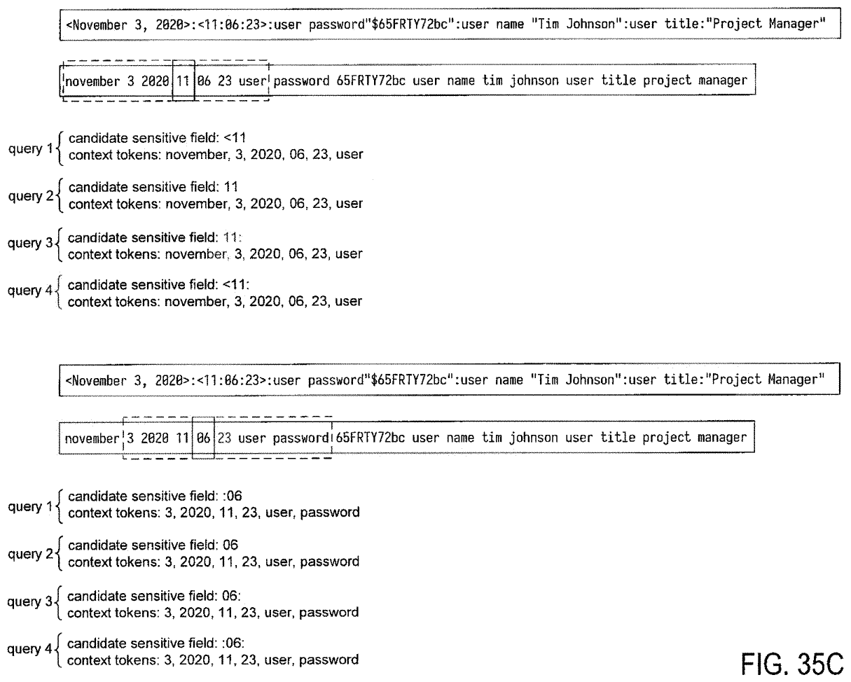

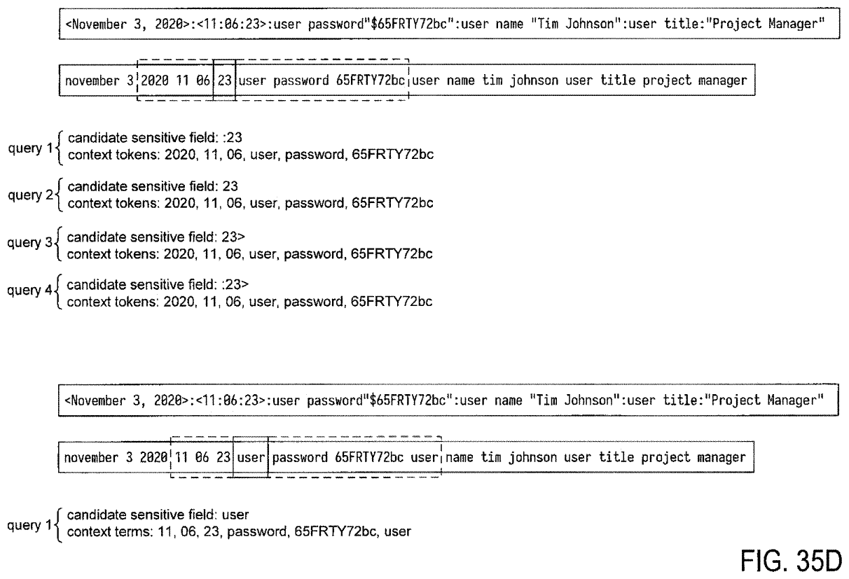

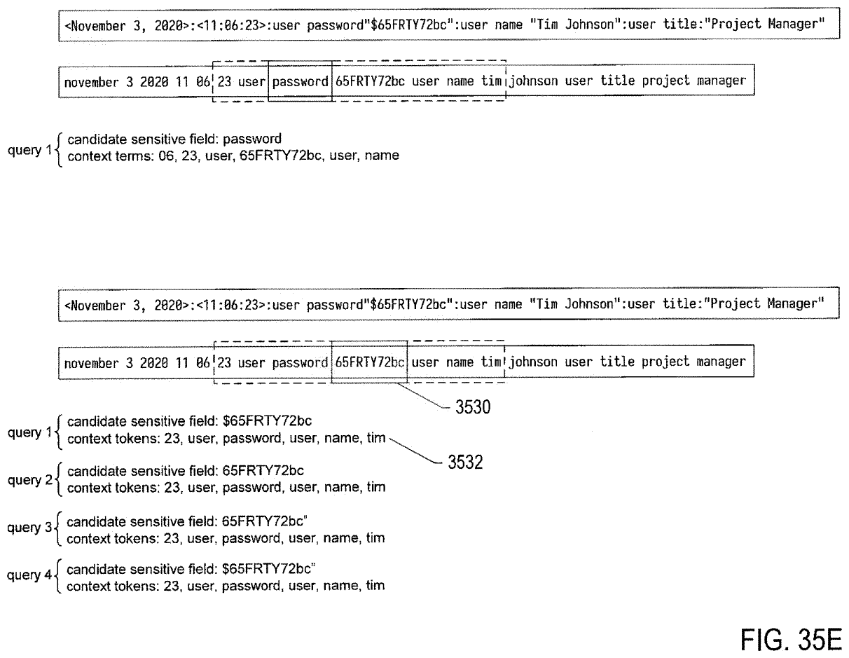

FIGS. 35A-E illustrate a windowing approach to analyzing a received log/event message to identify any sensitive fields within the received log/event message. An example log/event message 3502 is shown at the top of FIG. 35A. The text-processing operations discussed above with reference to FIG. 33 are applied to the received log/event message to generate a canonical log/event message 3504. The windowing approach involves a cursor 3506, which overlies a single token in the canonical log/event message at any given point in time and that is moved across the canonical log/event message m the course of analyzing the canonical log/event message for occurrences of sensitive fields. A pre-context window 3508 and a post-context window 3510 lie on either side of the cursor. The context windows, in a described implementation, generally each includes three characters, but may be shortened as the cursor approaches either end of the canonical log/event message. Finally, one or more queries of the general form 3512 are transmitted to the sensitive-field dictionary for each cursor position during the windowing operation in order to attempt to retrieve dictionary entries that may describe a sensitive field over which the cursor is positioned. The query requests any dictionary entries for which the text encompassed by the cursor satisfies the regular expression in the entry and for which a greater than threshold portion of the terms in the pre-context and post-context windows match contextual keywords in the entry. Again, as pointed out above, term matching is not specific for the pre-context or post-context, but is instead carried out for the full set of terms that occur in either or both of the pre-context and post-context.

A first portion of the windowing operation is next illustrated in FIGS. 35 B-E. As shown at the top of FIG. 35B, the cursor is first positioned 3520 over the first term “november” in the canonical log/event message. Referring back to the log/event message 3502 from which the canonical log/event message was generated, this first term may be a sensitive field or the term “<November” may also be a sensitive field, since the character “<” was removed during generation of the canonical log/event message. Therefore, the two queries 3522 are be issued to the sensitive-field dictionary in order to discover dictionary entries that indicate that either “November” or “<november” is a sensitive field. Dictionary entries that are returned for these queries are evaluated to determine whether the cursor is positioned entirely over, or over a portion of, a sensitive field. Then, as shown in a next step, the cursor is moved rightward to overlie the term “3” 3524 and two additional queries 3526 are transmitted to the sensitive-field dictionary. The step-by-step cursor placement and query transmission operations continue through the remainder of FIG. 35B and FIGS. 35C-E with the cursor, in the final illustrated step, placed over an actual sensitive field 3530. The first query 3532 generated for this cursor position will, in fact, retrieve a dictionary entry representing this sensitive field. Thus, a systematic windowing operation combined with the sensitive-field dictionary can be used to locate each sensitive field within a log/event message received by a log/event-message subsystem. The remaining cursor-placement and query-transmission operations carried out in this example are not shown in the figures. In alternative implementations, lists of all possible regular expressions for the different possible variants of the portion of a log/event message corresponding to a canonical token in a canonical log/event message can be generated and maintained, so that, rather than issuing multiple queries for each canonical token, a single query can be issued.

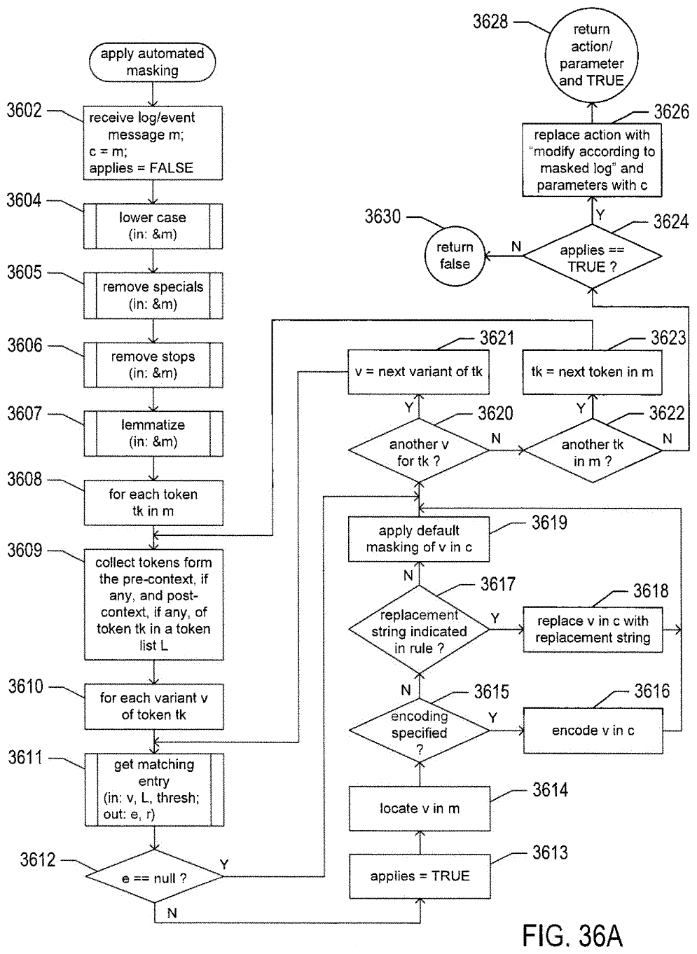

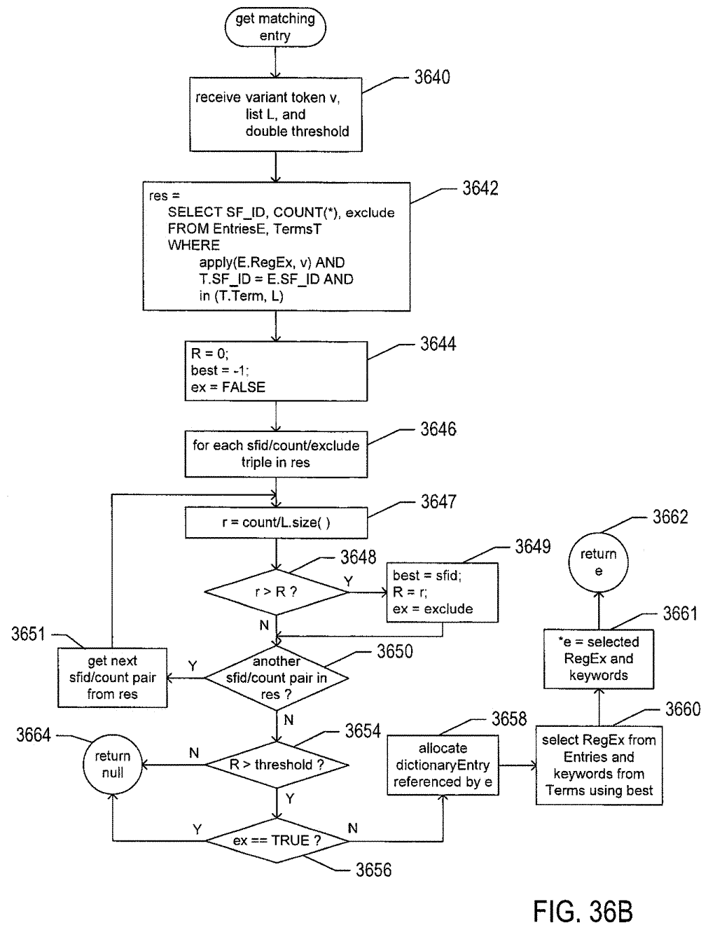

FIGS. 36A-B provide control-flow diagrams that illustrate application of automated masking to a received log/event message. As discussed above, the currently described implementation employs automated-masking rules to activate and deactivate automated masking in order to make use of the rule-based machinery for message processing discussed above with reference to FIGS. 17A-C, FIG. 36A provides a control-flow diagram for a routine “apply automated masking.” In step 3602, the routine “apply automated masking” receives a log/event message m, generates a copy c of the log/event message m, and sets a local variable applies to FALSE. In steps 3604-3607, the text-processing operations discussed above with reference to FIG. 33 are applied to the received log/event message m in order to generate a canonical log/event message, as discussed above with reference to FIG. 35A. In the nested for-loops of steps 3608-3623, each token tk in the now canonical log/event message m, and each possible variant v of the token, are considered. As discussed above, a token variant refers to one of multiple possible sensitive fields in the original log/event message that correspond to a canonical token or term in the canonical log/event message m. In step 3609, the context tokens are collected into a token list L. In step 3611, a routine “get matching entry” is called to retrieve any entries in the sensitive-field dictionary that match the currently considered token tk and the collected context tokens in list L. A threshold is supplied as one of the input arguments for use in determining whether or not a sufficient number of context tokens match contextual keywords in the dictionary entry for a match to occur. When the routine “get matching entry” returns a null pointer, as determined in step 3612, control flows to step 3620, which is the final step in the current iteration of the inner for-loop of steps 3610-3621. Otherwise, in step 3613, the local variable applies is set to TRUE, since the automated-masking rule applies to log/event message m. In step 3614, the currently considered token variant v is located in m. The location of the variant in m is also the location the token variant in copy c of log/event message ns. When the currently active automated-masking rule indicates that sensitive fields should be encoded, as determined in step 3615, the sensitive field in copy c is encoded in step 3616. Otherwise, when the currently active automated-masking rule indicates that sensitive fields should be replaced by a specified replacement string, as determined in step 3617, the sensitive field in copy c is replaced with the specified replacement string in step 3618. Otherwise, default masking of sensitive field v in c is carried out in step 3619. Following completion of the nested for-loops of steps 3608-3623, when the local variable applies has the value TRUE, as determined in step 3624, a replacement action and a parameters portion that includes the message copy c are generated, in step 3626, and returned in step 3628. Otherwise, the routine “apply automated masking” returns FALSE in step 3630.

FIG. 36B provides a control-flow diagram for the routine “get matching entry,” called in step 3611 of FIG. 36A. In step 3640, the routine “get matching entry” receives token variant v, a list of context terms L, and a match threshold. In step 3642, the routine “get matching entry” issues a query to the sensitive-field database for any sensitive-field identifiers included in any dictionary entries that include a regular expression compatible with variant v and at least one term included in list L, along with a count of the number of matching terms and the field exclude. In step 3644, local variable R is set to 0, local variable best is set to −1, and local variable ex is set to FALSE. In the for-loop of steps 3646-3651, the results returned from the query are evaluated in order to select the best result. In step 3647, local variable r is set to the ratio of matching terms to the total number of context terms. When the value stored in local variable r is greater than the value stored in local variable R, as determined in step 3648, the currently considered result is better than any of the previously evaluated results and, therefore, local variable best is set to the numerical identifier of the sensitive field corresponding to the currently considered result, local variable R is updated to the value stored in local variable r, and local variable ex is set to the Boolean value of the field exlude in the result. Following completion of the for-loop of steps 3646-3651, when R is greater than the specified threshold, as determined in step 3654, and when local variable ex does not have the value TRUE, as determined in step 3656, a dictionary entry is allocated, in step 3658, initialized with data from the sensitive-field dictionary in steps 3660-3661, and returned in step 3662. Otherwise, the routine “get matching entry” returns a null pointer in step 3664.

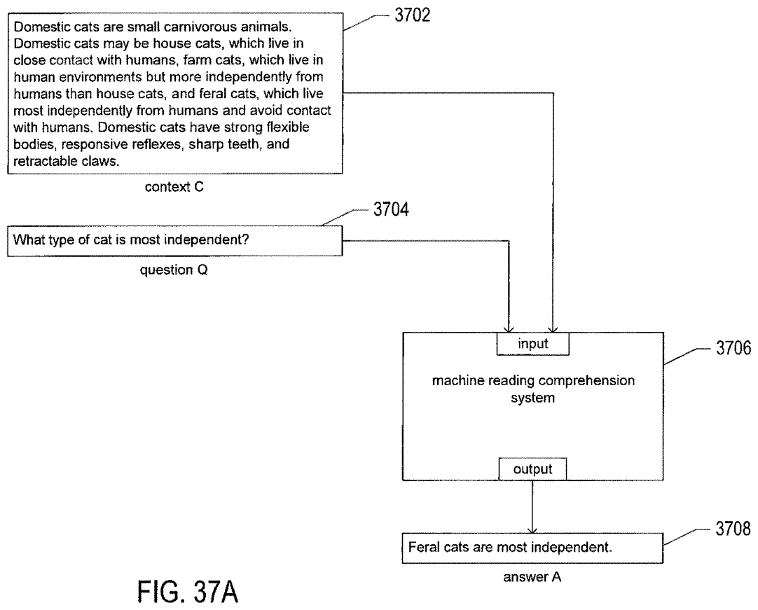

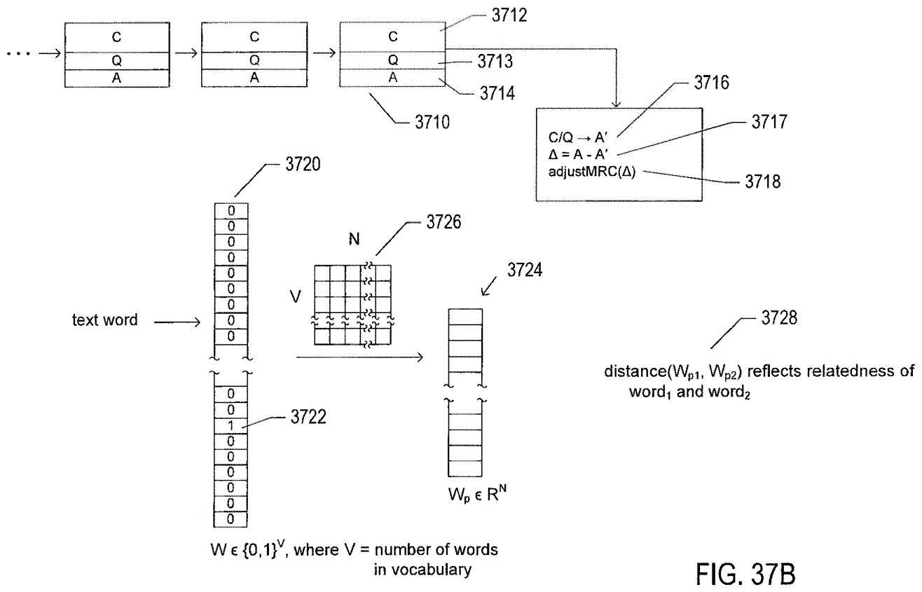

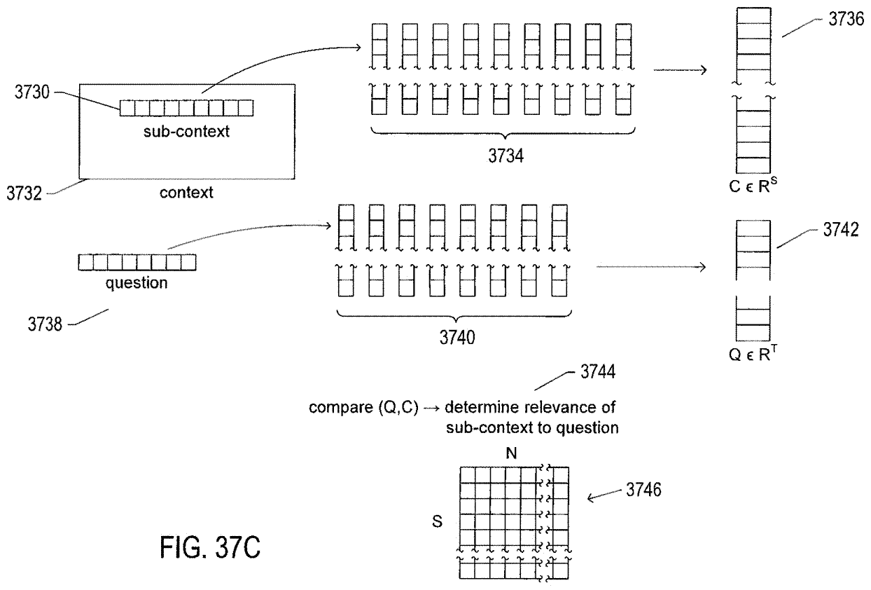

FIGS. 37A-C illustrate machine-reading-comprehension (“MRC”) systems. MRC systems are commonly used in natural-language processing for various operations that involve selecting phrases or sentences from contextual passages. One important example is for formulating answers to questions related to a contextual passage. In FIG. 37A, an example contextual passage 3702 and question 3704 are shown as inputs to an MRC system 3706. The MRC system generates an answer 3708 to the question. MRC systems do not attempt to actually understand the contextual passage, but instead use various types of vector-space-based operations and heuristics to identify portions of the contextual passage related to the question and then use the identified portions to answer the question. As shown in FIG. 37B, MRC question-answering systems need to be trained, using training data, in order to provide answers to questions. The training data consists of a series or stream of examples, such as example 3710, each of which includes a contextual passage 3712, a question related to the contextual passage 3713, and an appropriate answer to the question 3714. For each example in the training dataset, the MRC system generates a proposed answer A′ 3716, computes some type of distance metric between the proposed answer and the answer included in the training-data example 3717, and adjusts parameters and weights to minimize the distance 3718 were the proposed answer A′ recomputed using the adjusted parameters and weights.

In many MRC systems, words in the contextual passage and question are mapped to vectors. Initially, the words are mapped to a type of vector 3720 that includes a different element for each different word in the considered vocabulary. The mapping of a word to this type of vector results in a vector with a single entry, such as entry 3722 in vector 3720, having the value 1 and all other entries having the value 0. These vectors are elements of a vector space of dimension V, where V is the number of words in the vocabulary. These initial vectors are then mapped to vectors of a real-number-based vector space 3724 of much smaller dimension N by a mapping encoded in an V×N embedding matrix 3726, each row of which corresponds to an N-dimensional vector representing a particular word in the vocabulary. The mapping incorporates semantic relationships between words into the N-dimensional vectors so that a distance computed by vector subtraction of the two N-dimensional vectors reflects the semantic relationship between the words represented by the two vectors 3728. As shown in FIG. 37C, a subcontext 3731 of adjacent words within a contextual passage 3732 is initially represented as a set of corresponding word vectors 3734 which are submitted to various types of machine-learning entities, such as recurrent neural networks and convolutional neural networks, to generate a single-vector representation of the subcontext 3736. Similarly, a question 3738 is initially represented by a set of word vectors 3740 and then processed via machine-learning entities to produce a single vector 3742 representing the question. A comparison operation 3744, in certain implementations based on a matrix computed from the subcontext and question vectors 3746, can then be applied to the subcontext and question vectors in order to determine the relatedness of the question to the subcontext represented by the subcontext vector. An operation that considers successive contexts within the contextual passage and computes the relatedness of the question to each of the successive contexts can then determine those subcontexts most closely related to the question, which provides a basis for generating an answer to the question. MRC systems are well-known and mature, and there are many different types of MRC-system implementations used for a variety of different problem domains.

In certain implementations of the currently disclosed automated-masking subsystems, and MRC system is used for identifying sensitive fields within log/event messages. FIG. 38 illustrates training an MRC system to identify sensitive fields in log/event messages. A training data set 3802 is developed using a sensitive-field dictionary 3804, discussed above, and a large set of log/event messages 3806. The log messages are processed using the sensitive-field dictionary to generate examples, such as example 3808, which together comprise the training data set. Each example includes a log/event message, such as log/event message 3810 in example 3808, the question “What are the sensitive fields in the log?” 3812, and the answer 3814. When event types are computed for, and associated with, log/event messages, event types may also be included in the examples and also included with the log/event messages submitted to the trained MRC system. When an MRC system is trained with this training data, it can reliably identify the sensitive fields in log/event messages in the same way that a trained MRC system can provide answers to questions related to contextual passages.

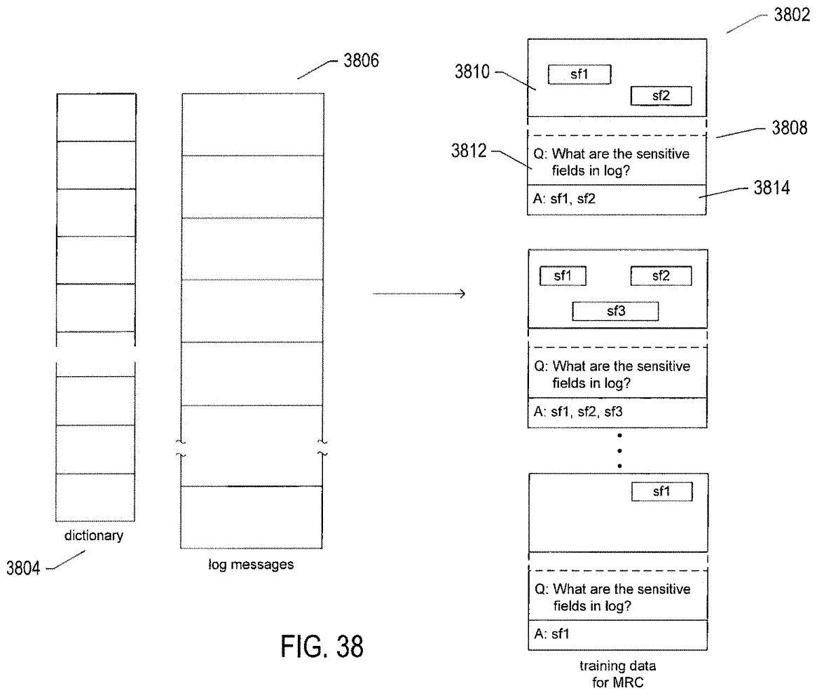

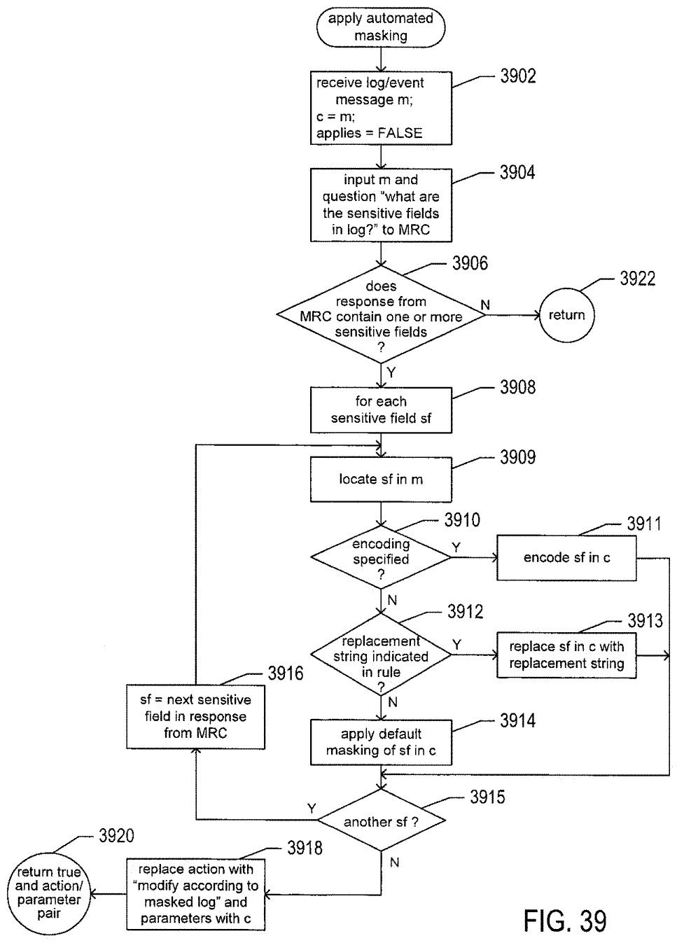

FIG. 39 provides an alternative implementation for the routine “apply automated masking,” discussed above with reference to FIGS. 36A-B. Step 3902 is identical to step 3602 in FIG. 36A. In step 3904, the above-mentioned question is input to an MRC system along with the received log/event message m. In alternative implementation, both the received log/event message m and a corresponding canonical log/event message generated by the processing steps discussed with reference to FIG. 33 are input to the MRC system, with the MRC system trained with examples that include received log/event messages as well as the corresponding canonical log/event message. When the response from the MRC system contains an indication of at least one sensitive field, as determined in step 3906, then, in the for-loop of steps 3908-3916, the sensitive fields indicated in the response from the MRC system are masked in the copy c of the log/event message m, as in FIG. 36A, and then an action/parameter pair is generated, in step 3918, and the action/parameter pair and the value TRUE are returned in step 3920. Otherwise, the value FALSE is returned in step 3922.

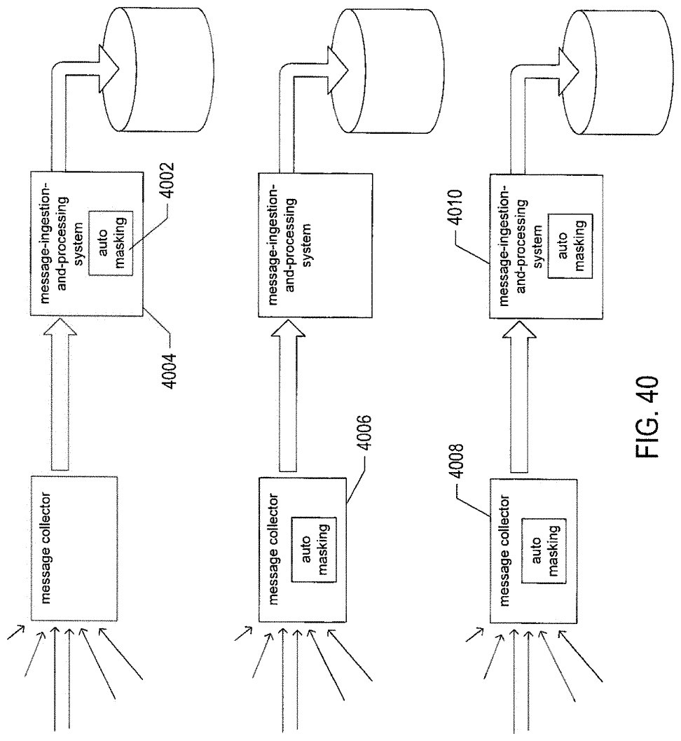

FIG. 40 illustrates incorporation of automatic-masking subsystem within a log/event-message subsystem. As indicated in FIG. 40, and automatic-masking subsystem 4002 may be incorporated within a message-ingestion-and-processing system 4004, within a message collector 4006, or within both message collectors 4008 and message-ingestion-and-processing systems 4010. Clearly, incorporation of an automatic-masking subsystem within message collectors best secures a log/event-message subsystem from inadvertent disclosure of sensitive fields contained in log/event messages. However, it may be desirable to incorporate automatic-masking at the message-ingestion-and-processing-system-level in order to take advantage of greater computational resources available at that level. In other cases, initial automatic masking may be carried out in message collectors to mask the most critical sensitive fields and subsequently, again at the message-ingestion-and-processing level in order to comprehensively mask the remaining, less critical sensitive fields.

The present invention has been described in terms of particular embodiments, it is not intended that the invention be limited to these embodiments. Modifications within the spirit of the invention will be apparent to those skilled in the art. For example, any of many different implementations of the log/event-message system can be obtained by varying various design and implementation parameters, including modular organization, control structures, data structures, hardware, operating system, and virtualization layers, and other such design and implementation parameters. There are a variety of additional methods that can be used to identify sensitive fields in log/event messages and many different types of automated masking that can be employed in addition to those discussed above.

1. An improved log/event-message system, within a distributed computer system, that collects log/event messages from log/event-message sources within the distributed computer system, stores the collected log/event messages, and provides query-based access to the stored log/event-messages, the log/event-message system comprising:
one or more message collectors, incorporated within one or more computer systems, each having one or more processors and one or more memories, which each
receives log/event messages,
processes the received log/event messages, and
transmits the log/event messages to one or more downstream processing components, including one or more message-ingestion-and-processing systems; and
the one or more message-ingestion-and-processing systems, incorporated within one or more computer systems, each having one or more processors and one or more memories, which each
receives log/event messages from one or more of the one or more message collectors,
processes the received log/event messages, and
transmits the log/event messages to one or more downstream processing components, including a log/event-message query system,
one or more of the one or more message collectors and the one or more message-ingestion-and-processing systems processing the received log/event messages by using one or more of an automatically generated sensitive-field dictionary and a trained machine-learning subsystem to mask sensitive fields in the log/event messages.

2. The log/event-message system of claim 1 wherein log/event-message sources include:
message-generation-and-reporting components of hardware components of the distributed computer system, including network routers and bridges, network-attached storage devices, network-interface controllers, and other hardware components and devices; and
message-generation-and-reporting components within computer-instruction-implemented components of the distributed computer system, including virtualization layers, operating systems, and applications running within servers and other types of computer systems.

3. The log/event-message system of claim 1 wherein log/event-messages include text, alphanumeric values, and/or numeric values that represent various types of information, including notification of completed actions, errors, anomalous operating behaviors and conditions, various types of computational events, warnings, and other such information.

4. The log/event-message system of claim 1 wherein a sensitive field in a log/event message includes confidential and/or protected information that could comprise the security of a distributed computer system, individual computer systems, or computer-system users if inadvertently exposed or accessed by malicious entities.

5. The log/event-message system of claim 4 wherein confidential and/or protected information may include one or more of:
login credentials;
a username;
a password;
an address and access credentials for a server, appliance, or subsystem within a distributed computer system;
a uniform resource locator (“URL”),
a port number;
a secret key and/or key hash;
an infrastructure-access key;
an address and/or identifier for an internal component of the distributed computer system;
a credit-card number;
a phone number;
a social-security number;
contact information; and
a filename.

6. The log/event-message system of claim 1 wherein a sensitive-field dictionary contains multiple dictionary entries, each dictionary entry including:
a regular expression that represents possible contents of a sensitive field; and
a list of canonical terms that are likely to occur in a canonical context of the sensitive field.

7. The log/event-message system of claim 6 wherein one or more of the one or more message collectors and the one or more message-ingestion-and-processing systems process each of the received log/event messages by:
transforming the log/event message into a canonical log/event message;
for each canonical term in the canonical log/event message,
collecting matching sensitive-field-dictionary entries by identifying sensitive-field-dictionary entries that include a regular expression compatible with a portion of the received log/event message that includes the canonical term and that include at least one term in a set of canonical terms within a context of the canonical term in the canonical log/event message, and
when at least one matching sensitive-field-dictionary entry is collected,
selecting a best-matching sensitive-field-dictionary entry, and
when the best-matching sensitive-field-dictionary entry indicates that the corresponding sensitive field should be masked, masking the portion of the received log/event message that includes the canonical term compatible with the regular expression of the best-matching sensitive-field-dictionary entry.

8. The log/event-message system of claim 7 wherein transforming the log/event message into a canonical log/event message further comprises:
transforming the log/event message into a case-adjusted message by one of:
transforming upper-case letters to lower-case letters, and
transforming lower-case letter to upper-case letters;
transforming the case-adjusted message into an alphanumeric message by removing non-alphanumeric, or special, characters;
transforming the alphanumeric message into a processed message by removing stop words, and
transforming the processed message into a canonical message by lemmatization pf the terms in the processed message.

9. The log/event-message system of claim 7 wherein the context of a particular canonical term in the canonical log/event message includes up to a fixed number of canonical terms preceding the particular canonical term in the canonical log/event message and up to a fixed number of canonical terms following the particular canonical term in the canonical log/event message.

10. The log/event-message system of claim 7 wherein selecting a best-matching sensitive-field-dictionary entry further comprises:
for each matching sensitive-field-dictionary entry in the collected matching sensitive-field-dictionary entries,
computing a ratio of a determined number of terms in the each matching sensitive-field-dictionary entry that occur in the context of the canonical term in the canonical log/event message to a total number of terms in the context of the canonical term in the canonical log/event message; and
selecting a sensitive-field-dictionary entry form the collected matching sensitive-field-dictionary entries with a greatest computed ratio.

11. The log/event-message system of claim 7 wherein masking the portion of the received log/event message that includes the canonical term compatible with the regular expression of the best-matching sensitive-field-dictionary entry further includes one of:
deleting the portion of the received log/event message;
replacing the portion of the received log/event message with a fixed-length replacement string;
replacing the portion of the received log/event message with a variable-length replacement string; and
encoding the portion of the received log/event message to produce an encoded portion and replacing the portion of the received log/event message with the encoded portion.

12. The log/event-message system of claim 6 wherein one or more of the one or more message collectors and the one or more message-ingestion-and-processing systems process each of the received log/event messages by:
submitting the received log/event message to a trained MRC system along with a question; and
masking each portion of the received log/event message indicated to be a sensitive field by the MRC system.

13. The log/event-message system of claim 12 further including submitting a canonical version of the of the received log/event message along with the received log/event message to the MRC system, the canonical version of the of the received log/event message generated by:
transforming the log/event message into a case-adjusted message by one of:
transforming upper-case letters to lower-case letters, and
transforming lower-case letter to upper-case letters;
transforming the case-adjusted message into an alphanumeric message by removing non-alphanumeric, or special, characters;
transforming the alphanumeric message into a processed message by removing stop words, and
transforming the processed message into a canonical message by lemmatization pf the terms in the processed message.

14. The log/event-message system of claim 1 wherein the sensitive-field dictionary is automatically created by a dictionary-creation subsystem that:
receives sensitive-field information from each of multiple data sources;
converts the received sensitive-field information into pre-context/sensitive-field/post-context triples annotated with sensitive-field types; and
sequentially generates a dictionary entry for each sensitive-field type from the converted sensitive-field information for that sensitive-field type.

15. The log/event-message system of claim 1 wherein the MRC system is trained using examples generated from the sensitive-field dictionary.

16. A method that improves a log/event-message system within a distributed computer system that collects log/event messages from log/event-message sources within the distributed computer system, stores the collected log/event messages, and provides query-based access to the stored log/event-messages, the method comprising:
using one or more of an automatically generated sensitive-field dictionary and a trained machine-learning subsystem to identify sensitive fields in received log/event messages that need to be masked; and
masking the sensitive fields that need to be masked.

17. The method of claim 16 wherein a sensitive-field dictionary contains multiple dictionary entries, each dictionary entry including:
a regular expression that represents possible contents of a sensitive field; and
a list of canonical terms that are likely to occur in a canonical context of the sensitive field.

18. The method of claim 16 further comprising identifying sensitive fields in a received log/event message by:
transforming the log/event message into a canonical log/event message;
for each canonical term in the canonical log/event message,
collecting matching sensitive-field-dictionary entries by identifying sensitive-field-dictionary entries that include a regular expression compatible with a portion of the received log/event message that includes the canonical term and that include at least one term in a set of canonical terms within a context of the canonical term in the canonical log/event message, and
when at least one matching sensitive-field-dictionary entry is collected,
selecting a best-matching sensitive-field-dictionary entry, and
when the best-matching sensitive-field-dictionary entry indicates that the corresponding sensitive field should be masked, masking the portion of the received log/event message that includes the canonical term compatible with the regular expression of the best-matching sensitive-field-dictionary entry.

19. The method of claim 16 further comprising identifying sensitive fields in a received log/event message by:
submitting the received log/event message to a trained MRC system along with a question; and
masking each portion of the received log/event message indicated to be a sensitive field by the MRC system.

20. A physical data-storage device that stores computer instructions that, when executed by processors within computer systems of a log/event-message system within a distributed computer system, control the log/event-message system to process received log/event messages by:
using one or more of an automatically generated sensitive-field dictionary and a trained machine-learning subsystem to identify sensitive fields in the received log/event messages; and
masking the sensitive fields.
